(19) United States
(12) Patent Application Publication
(10) Pub. No.: US 2024/0053215 A1
(43) Pub. Date: Feb. 15, 2024

(54) INTERNAL FAULT DETECTOR AND METHODS OF USING SAME

(71) Applicant: IFD TECHNOLOGIES INC., Vancouver (CA)

(72) Inventors: Thomas Jacob ZUIDERVEEN, Vancouver (CA); Yen-You LIN, Richmond (CA); Audrey Joy Corrine SIEBERT-TIMMER, Vancouver (CA); John Paul CHISHOLM, Vancouver (CA); Jeremy Michael VAN HORN, Vancouver (CA); Elizabeth Sarah Smith PRICE, Vancouver (CA); Allison GIANNAROS, Vancouver (CA); Amanda Mahn Hah TUEY, Vancouver (CA); Adrian Bernard SILGARDO, (US); Justin George PEZZIN, (US); Richard Luke GRANDBOIS, (US); Braden David Seung-Jin SCOTT, Vancouver (CA)

(21) Appl. No.: 18/278,140

(22) PCT Filed: Feb. 23, 2022
(86) PCT No.: PCT/CA2022/050258

§ 371 Date: Aug. 21, 2023

Related U.S. Application Data
(60) Provisional application No. 63/153,677, filed on Feb. 25, 2021.

(51) Int. Cl. G01L 23/02; G01L 23/32; F16K 17/04; F16K 37/00

(52) U.S. Cl. CPC G01L 23/02; G01L 23/32; F16K 17/042; F16K 37/0008; F16K 17/0453

(57) ABSTRACT

A fault detector for detecting the occurrence of a rapid pressure rise within electrical equipment. The fault detector has a chamber having an interior, a diaphragm in sealing engagement with the chamber and an aperture providing fluid communication between the interior of the chamber and the external environment of the chamber.

### CROSS-REFERENCE TO RELATED APPLICATIONS

This application claims priority to, and the benefit of, United States provisional patent application No. 63/153,677 filed 25 Feb. 2021, the entirety of which is incorporated by reference herein for all purposes.

### TECHNICAL FIELD

Some embodiments of the present invention relate to apparatus or methods for monitoring the performance of electrical equipment such as transformers, reactors, capacitors and the like. Some embodiments of the present invention relate to apparatus or methods for detecting and/or indicating faults in electrical equipment. Some embodiments of the present invention have particular application in electrical components used in electrical power distribution systems.

### BACKGROUND

Electrical power distribution grids use electrical components, such as transformers, capacitors, and reactors. Potentially dangerous conditions can be created in such devices when aging or operating stresses cause the insulation system to fail. A short circuit within such a device can release a large amount of energy within a fraction of a second. In the worst case the device can explode due to rapid internal pressure buildup from the vaporization of insulating oil and the decomposition of the oil vapor into combustible or volatile gases.

It is known that there is a transient or rapid rise in pressure inside oil-filled electrical devices, such as transformers or voltage regulators, when the devices suffer from an internal arcing fault. This happens because arcing produces a local vaporization of some of the oil or insulating fluid. Some electrical devices are filled with electrically insulating gases such as SF₆. Devices for detecting such rapid pressure rises, and for indicating that such rapid pressure rises have occurred within an electrical device, are known, for example as described in U.S. Pat. Nos. 6,812,713, 6,429,662, 5,078,078, and Patent Cooperation Treaty publication Nos. WO 2011/153604, WO 2016/134458, all of which are hereby incorporated by reference herein. Such devices may also include a pressure relief valve or burst disk for relieving a buildup of pressure within the electrical device during normal operation.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect, a fault detector for detecting the occurrence of a rapid pressure rise can have a chamber having an interior, a diaphragm in sealing engagement with the chamber to define a portion of the surface of the chamber, and an aperture providing fluid communication between the interior of the chamber and an external environment of the chamber, the diaphragm having a spring constant of 5 lbs/inch or less.

In one aspect, a fault detector for indicating the occurrence of a rapid pressure rise within a housing of an electrical device has a barrel, an actuating mechanism in fluid communication with an interior of the housing, the actuating mechanism has a chamber, the chamber being sealed and having an orifice communicating between an external environment of the chamber and an interior of the chamber, and an actuating member movable in response to a pressure differential between the interior of the housing and the interior of the chamber, and the actuating member has a spring constant of 5 lbs/in or less. A plunger is provided within a bore of the barrel, the plunger biased forwardly in the barrel and normally retained in an armed position by the actuating member, and when the pressure differential exceeds a positive threshold value, the actuating member is moved and thereby permits the plunger to move forwardly into a triggered position.

In one aspect, a fault detector for indicating the occurrence of a rapid pressure rise within a housing of an electrical device has a barrel, an actuating mechanism in fluid communication with an interior of the housing, the actuating mechanism has a chamber, the chamber being sealed and having an orifice communicating between an external environment of the chamber and an interior of the chamber, and an actuating member is movable in response to a pressure differential between the interior of the housing and the interior of the chamber to cause the actuating member to move from an unactivated configuration to an activated configuration. A plunger is provided within a bore of the barrel, and a locking member having a first position and a second position is provided, wherein in the first position the locking member is positioned to restrain forward movement of the plunger in the barrel and to prevent a transfer of forces applied to the plunger to the actuating member and in the second position the locking member is positioned to allow forward movement of the plunger, the plunger being initially retained in the unactivated configuration by the locking member when the locking member is in the first position and the plunger being movable forwardly within the bore of the barrel when the locking member is in the second position.

In one aspect, a fault detector for indicating the occurrence of a rapid pressure rise within a housing of an electrical device is provided, having a barrel, an actuating mechanism in fluid communication with an interior of the housing and configured to release an actuating member in response to a rapid pressure rise within the housing, a plunger within a bore of the barrel, the plunger biased forwardly in the barrel and normally retained in an armed position by the actuating member, and a static seal having a first end fixedly retained on the plunger and a second end fixedly retained on the barrel, the static seal having a central portion that permits relative movement of the plunger and the barrel when the fault detector moves from an armed to a triggered configuration while maintaining a seal between the interior of the housing and an external environment of the housing.

In some aspects, a Hall effect sensor can be used to detect relative movement of the plunger and the barrel, to generate a signal that a rapid pressure rise has occurred.

In one aspect, a pressure relief valve for releasing pressure from an electrical device is provided, having a one-way flow obstructer that, in use, decreases an inward flow of fluid into an interior of the housing of the electrical device relative to an outward flow of fluid exiting the interior or the housing. The one-way flow obstructer can be an axially movable sealing sleeve.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a partially cut away schematic view of an electrical power transformer, mounted on a power distribution pole, equipped with an internal fault detector according to the invention and connected to an energy supply.

FIG. 2 is a perspective cross-sectional view of an embodiment of an internal fault detector.

FIG. 3 is an exploded view of the embodiment of FIG. 2, with a portion of the housing omitted for clarity.

FIG. 4 is a cross-sectional view of the actuator mechanism of the embodiment of FIG. 2.

FIG. 5A is a perspective view and FIG. 5B is a cross-sectional view of a preconvoluted diaphragm according to an example embodiment of the invention. FIG. 5C is a cross-sectional view of a top hat diaphragm.

FIG. 6 is a perspective view of a collar and inner and outer portions of a barrel.

FIG. 7 is a bottom plan view of an embodiment of an internal fault detector including an anti-rotation tab and a drainage aperture.

FIG. 8 is a schematic view showing one possible arrangement for preventing the rotation of a barrel of an embodiment of an internal fault detector in an aperture in a housing.

FIGS. 9A and 9B show perspective views of a seal for sealing between a barrel and a plunger when installed in internal fault detectors of the present invention in armed and triggered configurations, respectively.

FIGS. 10A and 10B show the positioning of a seal between a barrel and a plunger according to an example embodiment of an internal fault detector when the internal fault detector is in an armed configuration and in a triggered configuration, respectively.

FIG. 11 is a perspective view of a lock bar according to an example embodiment of the invention.

FIG. 12 is a perspective view of the lock bar of FIG. 11 assembled together with an inner portion of a barrel.

FIG. 13A is a perspective view and FIG. 13B is a side view of a shuttle according to an example embodiment of the invention.

FIG. 14A is a perspective view from the top of the inner end of an indicator according to an example embodiment. FIG. 14B is a perspective view from the bottom showing an example assembly of an inner end of a plunger, a biasing spring, and a shuttle. FIG. 14C is a cross-sectional view showing portions of an indicator mechanism in transition between an armed configuration and a triggered configuration. FIG. 14D is a cross-sectional view showing portions of an indicator mechanism in a triggered configuration. FIG. 14E is a perspective view showing relative positions of a lock bar and a shuttle in the unactivated configuration. FIG. 14F is a perspective view showing relative positions of a lock bar and shuttle in the activated configuration. FIGS. 14G and 14H are partial side and cross-sectional views respectively showing the shuttle and lock bar in the unactivated configuration. FIGS. 14I and 14J are partial side and cross-sectional views respectively showing the shuttle and lock bar in the activated configuration.

FIG. 15A is a perspective view of an embodiment of an internal fault detector in an armed state. FIG. 15B is a perspective view of an embodiment of an internal fault detector in a deployed state.

FIG. 16 is a perspective cross-sectional view of an internal fault detector according to an embodiment of the invention wherein a coil spring is used to provide a bias force on an indicator, which shows internal fault detector in the armed configuration and the pressure relief valve in the open configuration.

FIG. 17 is a cross-sectional view of a pressure relief valve according to an example embodiment of the invention.

FIG. 18A shows a side view of a dust cover engaged with a spring retainer for a pressure relief valve of an embodiment of an internal fault detector. FIG. 18B is an exploded perspective view of the embodiment of FIG. 18A.

FIG. 19 is a perspective view of an embodiment of an internal fault detector including an installed shipping lock.

FIG. 20A is a close up view of an embodiment of a shipping lock. FIG. 20B is a close up perspective view of the outer end of a barrel of an embodiment of an internal fault detector showing the features that engage with the shipping lock.

FIG. 21A is a cross-sectional view of an internal fault detector according to an embodiment wherein a shipping lock is installed. FIG. 21B is a detailed view of the interface between the actuator mechanism and the indicator mechanism in the internal fault detector of FIG. 21A.

FIG. 22A is a partial enlarged view showing an example embodiment of a one-way flow obstructer used in conjunction with an embodiment of a pressure relief valve when internal pressure is being vented. FIG. 22B is a view thereof when the interior of the housing is under vacuum (i.e. is at a pressure lower than atmospheric pressure) when internal pressure is being equalized.

FIG. 23A is a perspective view of an example embodiment of a magnetic sensor. FIG. 23B is an exploded perspective view thereof.

FIG. 24A-24C are perspective views showing an example means for decoupling an actuator mechanism from an indicator mechanism through the use of a transversely-oriented lock bar.

FIG. 25A-25C are perspective views showing an example means for decoupling an actuator mechanism from an indicator mechanism through the use of a pivoting lock bar for selectively engaging with a trigger pin of the actuator mechanism.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the relative directional terms “up”, “down”, “top”, “bottom”, “vertical”, “horizontal”, and the like, are used with reference to the intended orientation of an internal fault detector in its installed configuration in typical exemplary embodiments. The relative directional terms “forward”, “front” and the like are used with reference to the direction defined by the outer radial direction of a generally cylindrical transformer housing. Conversely, the relative directional terms “rearward”, “rear” and the like are used with reference to the direction defined by the inner radial direction of the transformer housing. It will be appreciated that such terms are relative only, and that the internal fault detector could have other orientations when not in use, and that the internal fault detector could be installed in alternative orientations than the exemplary configurations described herein and still perform the same function. As used herein, the term “axial” refers to a direction along a longitudinal axis of a barrel of the internal fault detector.

An internal fault detector as described herein can be used with a variety of high power electrical devices, including pole-type transformers, padmount transformers, or voltage regulators. While an example embodiment is described with reference to an oil-filled pole-type transformer, some embodiments of the invention are also used with gas-filled transformers.

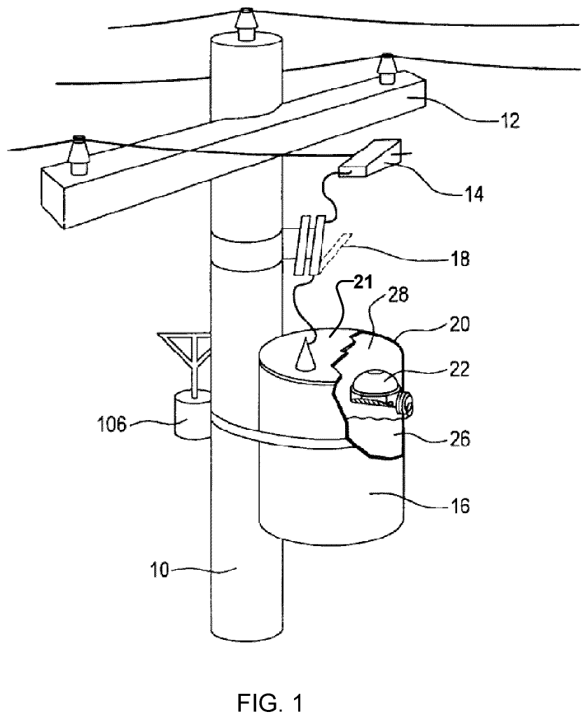

FIG. 1 shows an example embodiment of an internal fault detector 22 used in conjunction with an oil-filled pole-type transformer. A typical distribution pole 10 has a crossarm 12 supporting power lines 14.

Transformer 16 has a housing or “tank” 20. An example embodiment of an internal fault detector 22 is mounted in an aperture (not shown) in a side wall of tank 20. In some embodiments, the aperture is a small hole, and may have for example a diameter of approximately 1.35 inches (34.0 mm), which is a commonly used hole size for inserting various equipment onto transformers and the like. Tank 20 contains electrically insulating fluid 26, which may be for example an oil such as insulating mineral oil or Nynas Nytro™ (made from naphthenic oils), or an ester-based fluid such as Envirotemp FR3™ fluid (made from seeds), or an electrically insulating gas such as SF₆. Internal fault detector 22 is located in an air space 28 above the level of electrically insulating fluid 26 in tank 20 for fluid-filled transformers, or preferably above the core or coil for gas-filled transformers.

While the internal fault detector 22 illustrated in FIG. 1 is mounted in the side of tank 20, in alternative embodiments, internal fault detector 22 is installed through an aperture formed in the lid 21 of tank 20. In some such embodiments, installing internal fault detector 22 in the lid 21 of tank 20 allows internal fault detector 22 to be installed at a higher position in tank 20, and may provide for increased sensitivity of internal fault detector 22 and/or facilitate installation of internal fault detector 22.

In still further alternative embodiments, the internal fault detector 22 could be installed partially or entirely outside of tank 20, for example as might be done to retrofit an existing transformer, so long as the internal fault detector 22 is placed in fluid communication with the interior of tank 20, so that changes in pressure within tank 20 will be conveyed to internal fault detector 22.

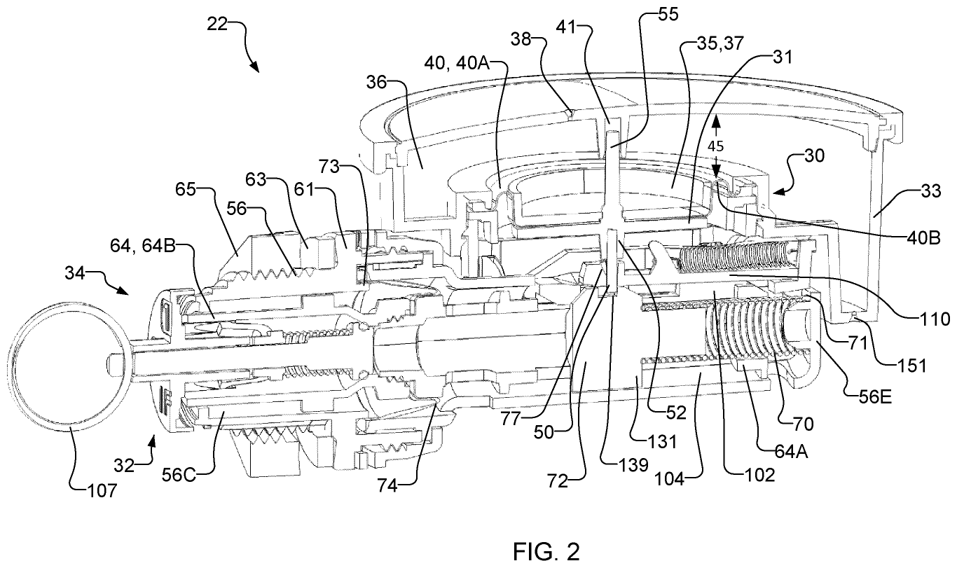

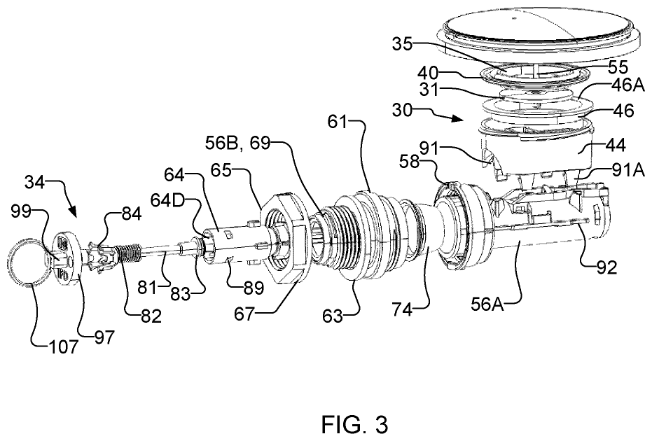

With reference to FIGS. 2 and 3, internal fault detector 22 has an actuator mechanism, indicated generally by 30, which detects rapid pressure rises within housing 20, and an indicator mechanism, indicated generally by 32, which changes appearance when the actuator mechanism 30 has detected a rapid pressure rise. As used herein, “rapid pressure rise” means a change in pressure having a peak pressure that is greater than approximately 0.1 to 20 or more pounds per square inch (psi) within a rise time period of approximately 5-15 milliseconds. This includes all values and subranges within these ranges, e.g. 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, 3.0, 3.5 4.0, 4.5, 5.0, 6, 7, 8, 9, 10, 12, 14, 16 or 18 or more psi within a period of 6, 7, 8, 9, 10, 11, 12, 13 or 14 milliseconds. Different embodiments of internal fault detector 22 may have different levels of sensitivity to a rapid pressure rise, depending on the desired application. Alternative ways of modulating the sensitivity of internal fault detector 22 are discussed below.

As an example, when there is a breakdown of the insulation surrounding the energized or “active” components of transformer 16, an arc can be created. Other scenarios in which arcs are created include cases where short circuits occur, or in the case of manufacturing defects or parts contacting one another, or cases where the dielectric strength of the insulation surrounding the active transformer components is insufficient. The electric arc dissipates large amounts of energy. The sudden dissipation of energy within housing 20 causes a sharp rise in the pressure within housing 20. Even at levels of short circuit current on the order of 100 amperes, the pressure within housing 20 rises at a rate which is distinctly higher than other pressure fluctuations that are reasonably expected to occur during normal operation of transformer 16. This rapid pressure rise, i.e. a transient pressure rise, is detected by actuator mechanism 30, which triggers indicator mechanism 32. That is, a rapid pressure rise causes indicator 32 to be triggered from an armed configuration to a triggered configuration.

To facilitate normal operations and pressure changes expected during normal operating conditions, internal fault detector 22 may include a pressure relief valve 34. If the pressure rises to a value which is greater than the set point of pressure relief valve 34, then pressure relief valve 34 opens until the pressure has been relieved. The pressure within housing 20 may rise to a level capable of opening pressure relief valve 34 as a result of normal fluctuations in ambient temperature and loading. Service personnel may also manually operate pressure relief valve 34, as described below, to equalize the ambient pressure inside housing 20 with the air pressure outside of housing 20.

As best illustrated in FIGS. 2 and 3, actuator mechanism 30 has a chamber 36 which is in fluid communication with the interior of housing 20 only by way of a small orifice 38 located on shell 33. That is, chamber 36 is generally sealed except for a small orifice 38 which places the interior of chamber 36 in fluid communication with the interior of housing 20. In the illustrated embodiment, a diaphragm 40, which functions as a gas barrier, forms one wall of chamber 36. A second wall of chamber 36 is provided by shell 33.

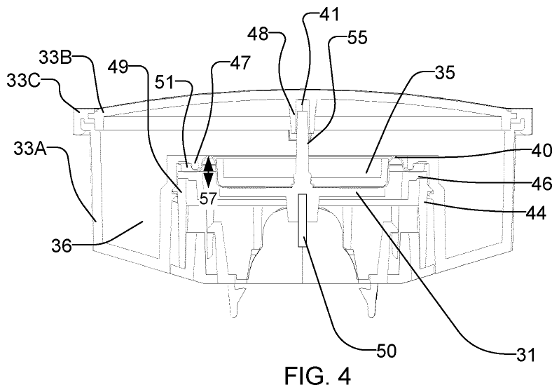

In some embodiments, shell 33 comprises a plurality of adjoined components. As best illustrated in FIG. 4, shell 33 comprises actuator housing walls 33A. An exterior face of walls 33A comprises a downwardly extending generally cylindrical wall while interior faces of walls 33A comprise features for interfacing with other components of actuator mechanism 30 as later discussed herein. Shell 33 additionally comprises a lid 33B for enclosing an upper end of actuator mechanism 30 from the interior of housing 20. Lid 33B may be secured to actuator housing walls 33A in any suitable manner (e.g. by clips, clamps, adhesives, ultrasonic welding, overmolding, or the like). In the illustrated embodiment, an overmolded part 33C substantially covers and attaches to exterior interfacing edges of walls 33A and lid 33B. In other embodiments, an entire shell 33 is integrally formed.

Diaphragm 40 has one face 40A in chamber 36 and a second face 40B exposed to the ambient pressure of housing 20, whether by being positioned within housing 20 or by being placed in fluid communication with the interior of housing 20. Chamber 36 is preferably roughly semi-spherical so that it can occupy a reasonably small space if positioned within housing 20, although chamber 36 may have other shapes. Diaphragm 40 preferably has a reasonably large surface area so that pressure differentials across diaphragm 40 will generate sufficient forces to trigger indicator mechanism 32. In some embodiments, diaphragm 40 may have a diameter of 3 inches or more. In other embodiments, smaller diameters such as diameters in the range of 0.5 to 2 inches may be used for diaphragm 40, including any value therebetween, e.g. 0.6, 0.7, 0.8, 0.9, 1.0, 1.1, 1.2, 1.3, 1.4, 1.5, 1.6, 1.7, 1.8 or 1.9 inches.

In the illustrated embodiment, a spindle 31 is provided to provide support for diaphragm 40 in the downward direction. A support wheel 35 may be provided to support diaphragm 40 in the upward and inward radial directions. Support wheel 35 comprises a vertical circular projection 37 generally defined by an interior radial surface of diaphragm 40. From the bottom of circular projection 37, support wheel 35 extends radially inwardly, conforming substantially to an inner portion of face 40A of diaphragm 40. Support wheel 35, being made from a more rigid material than diaphragm 40, protects diaphragm 40 from damage that could be caused by excessive deflection. Other designs and configurations for spindle 31 and support wheel 35 may also be used to support diaphragm 40. For example, the spindle may be formed from a plurality of connected concentric rings, as a sheet of suitably resilient material, or the like.

The size and shape of chamber 36 can also affect the sensitivity of indicator mechanism 32. For example, the height 45 of chamber 36 above surface 40A of diaphragm affects the sensitivity, and different heights can be used depending on the type of equipment in which internal fault detector 22 is deployed. For example, in transformers or voltage regulators having a larger air space, a larger cup volume may be provided, e.g. by making height 45 taller. In some embodiments, height 45 of chamber 36 above surface 40A of diaphragm 40 could be on the order of about 0.5 to about 3 inches, including any value or subrange therebetween, e.g. 0.75, 1.0, 1.25, 1.50, 1.75, 2.00, 2.25, 2.50 or 2.75 inches.

Because air can enter or leave chamber 36 by way of orifice 38, the air pressure within chamber 36 will track relatively slow changes in ambient pressure within housing 20. Such changes might occur, for example, when the temperature within transformer 16 changes. On the other hand, if the pressure within housing 20 increases very suddenly, the air pressure within chamber 36 will take some time to increase because of the small size of orifice 38. In response to a rapid pressure rise, diaphragm 40 should move far enough to reliably trigger indicator mechanism 32. During this period, the pressure on face 40B of diaphragm 40 will temporarily significantly exceed the pressure on face 40A. Diaphragm 40 is thus pushed inwardly toward chamber 36 resulting in translational movement of diaphragm 40 in the axial direction.

A rapid pressure rise would occur, for example, if an electrical fault in the active components of transformer 16 caused an electrical arc within housing 20. Diaphragm 40 should be insensitive to fluctuations in the ambient pressure within housing 20 which occur more slowly than about 1 psi per second, to avoid triggering internal fault detector 22 due to lower changes in internal pressure than would be caused by an internal fault.

A splash cover 44 may be provided to dampen the effects of oil splashing onto diaphragm 40, as might occur, for example, if housing 20 was shaken by an earthquake. A spacer ring 46 interposes diaphragm 40 and splash cover 44 to elevate diaphragm 40 above the surface of splash cover 44. As best shown in FIGS. 3 and 4, spacer ring 46 is a circular ring having an outwardly extending shoulder 46A that encircles diaphragm 40, spindle 31 and support wheel 35.

Shell 33 may be secured to splash cover 44 in any suitable manner (e.g. by clips, clamps, adhesives, ultrasonic welding, overmolding, or the like). In the illustrated embodiment, a threaded part of inner portion 47 of shell 33 is threaded over a threaded part of outer portion 49 of splash cover 44. At the upper end of the threaded part of inner portion 47 where the threads terminate, inner portion 47 briefly extends inwardly to form a circular shape, and at the end of this extension, inner portion 47 comprises a downward projection (see FIG. 4).

When shell 33 is threaded over splash cover 44, the inward extension of inner portion 47 concentrically surrounds an outer circumferential lip 51. Upon threadingly engaging shell 33 over splash cover 44, the downward facing surface of lip 51 abuts against spacer ring 46 which in turn abuts against outer portion 49 of splash cover 44, thereby retaining diaphragm 40 within chamber 36. By retaining diaphragm 40 in such a configuration, the pressures of chamber 36 and the interior of housing 20 are sealed against one another except by air entering and leaving through orifice 38 and/or oil drain aperture 151, which is a small aperture provided to allow any oil that enters chamber 36 to exit. Providing spacer ring 46 is beneficial because the downward force exerted on diaphragm 40 by shell 33 can be distributed over the larger surface area of spacer ring 46. Advantageously, the secure retaining of diaphragm 40 in the illustrated configuration improves the seal between the interior of housing 20 and chamber 36, thereby increasing the sensitivity of actuator mechanism 30. Additional sealing may be provided, for example, by an O-ring disposed on the lower surface of the downward projection of inner portion 47, which interposes surface 40A and chamber 36.

An axial guide rod 55 extending from diaphragm 40 may project into a cavity 41. In such embodiments, the location of the upper end of axial guide rod 55 projecting into cavity 41 can be used to verify that diaphragm 40 has been properly located within chamber 36 during assembly. Additionally the projection of guide rod 55 into cavity 41 serves to limit excessive upward motion and to prevent the inversion of diaphragm 40, which may result in damage to diaphragm 40. In the illustrated embodiment, spindle 31 and guide rod 55 are integrally formed as a single unit. Although it is not necessary that these components are integrally formed, having fewer parts may permit easier assembly and may also provide for greater consistency in the deployment of internal fault detector 22 from unit to unit.

As best illustrated by FIG. 4, guide rod 55 projects into cavity 41 defined between a pair of opposed tabs 48 located on shell 33 having a tapered lower portion. Although not illustrated, in some embodiments, orifice 38 may be provided directly over top of cavity 41.

A trigger pin 50 extends downwardly from diaphragm 40 to retain plunger 64 in position until actuator mechanism 30 is triggered. Movement of diaphragm 40 in response to a rapid pressure rise triggers indicator mechanism 32 as described below. In the illustrated embodiment, trigger pin 50 projects from a pair of opposed tabs 52 integrally formed on a bottom surface of spindle 31. Trigger pin 50 may be retained between tabs 52 of spindle 31 by way of an interference fit. In other embodiments, tabs 52 are omitted from spindle 31 and trigger pin 50 is retained into a hub located in a central portion of diaphragm by an interference fit. In another embodiment, pin 50 is formed integrally with spindle 31. Under normal operating conditions, chamber 36 is exposed to various mechanical vibrations and shocks including seismic tremors. To avoid false triggering by such mechanical vibrations, and to permit rapid operation, the mass of diaphragm 40 should be small.

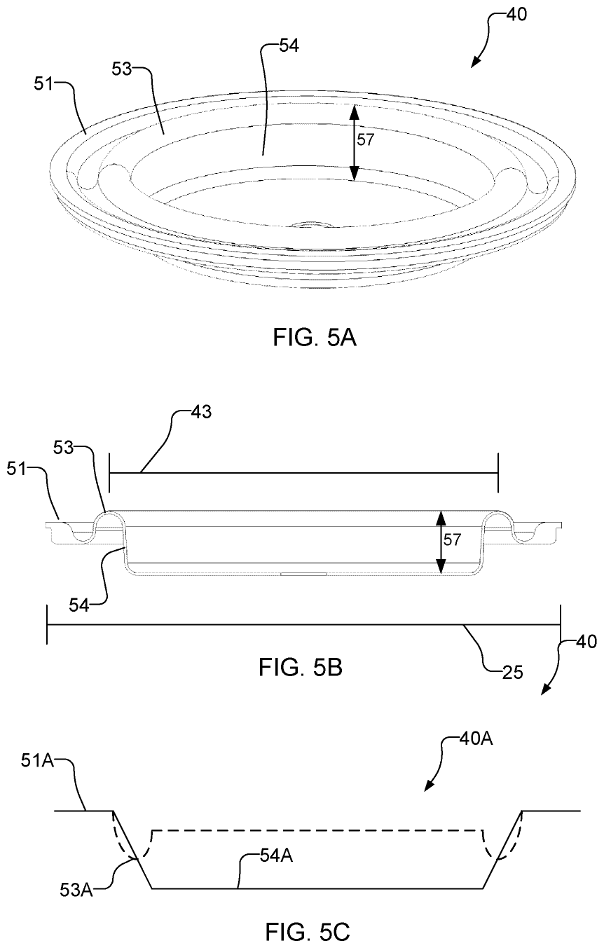

FIGS. 5A and 5B show a perspective view and a cross-sectional view of diaphragm according to an example embodiment of the invention. In the illustrated embodiment, the outer diameter of diaphragm 40 has a lip 51. As described herein, the construction of lip 51 permits diaphragm 40 to be secured within chamber 36 by way of clamping inner portion 47 of shell 33 and spacer ring 46 on opposing faces of diaphragm 40. However, any suitable mechanism or manufacturing technique could be used in alternative embodiments to sealingly engage diaphragm 40 with chamber 36 so that diaphragm 40 provides at least a portion of the surface of chamber 36.

A concentric annular ridge 53 having a diameter smaller than the external diameter of diaphragm 40 is provided on diaphragm 40 radially interiorly of lip 51. The ridge 53 can be described as a convolution in the shape of diaphragm 40, and diaphragm 40 as illustrated has one convolution. The convolution provided by annular ridge 53 has a diameter 43 that is less than a diameter 25 of diaphragm 40.

At the inner end of ridge 53, diaphragm 40 features a downwardly depending depression having a height 57 and extending radially inwards to form a shallow cup 54. In some embodiments, height 57 is in the range of 0.05 to 0.5 inches, including any value therebetween, e.g. 0.1, 0.2, 0.3, or 0.4 inches. In some embodiments, cup 54 has a diameter corresponding to diameter 43 in the range of 0.5 to 2.5 inches, including any value therebetween e.g. 0.6, 0.7, 0.8, 0.9, 1.0, 1.2, 1.4, 1.6, 1.8, 2.0, 2.2 or 2.4 inches. In some embodiments, cup 54 has a diameter of about 2 inches. In some embodiments, diaphragm has a total diameter 25 in the range of 0.5 to 5 inches, including any value therebetween, e.g. 0.6, 0.7, 0.8, 0.9, 1.0, 1.5, 2.0, 2.5, 3 or 4 inches.

A single convolution in diaphragm 40 as illustrated may be used for a number of reasons. The diameter 43 of the illustrated convolution is equal to the total diameter 25 of diaphragm 40 less the dimension of features radially outward of annular ridge 53. This diameter 43 establishes the surface area over which diaphragm 40 is sensitive to pressure rises in transformer 16. Diaphragms with a larger surface area will, generally speaking, be more sensitive to changes in pressure because they can generate more force for a given pressure acting on the diaphragm than a diaphragm with a smaller surface area. Where there are two or more convolutions, it has been found that only the diameter of the innermost convolution serves as the area for which diaphragm 40 is sensitive to pressure changes. A larger area that is sensitive to pressure changes has been found to result in an increased sensitivity of diaphragm 40 and actuator mechanism 30.

It has been found that the sensitivity of diaphragm 40 to pressure rises in transformer 16 depends in part on the geometry of diaphragm 40. In the case that zero convolutions are provided on diaphragm 40 (i.e. diaphragm 40 is generally flat with no convolution or cup), movement of diaphragm 40 in response to pressure rises depends solely on the elastic deformation of the material from which diaphragm 40 is made (i.e. any deflection of the centrepoint of diaphragm 40 arises solely as a result of the elastic deformation of such material). In contrast, the convolution provided by annular ridge 53 permits cup 54 to invert against itself in response to a pressure rise by changing the shape of cup 54, without the need for significant elastic deformation of the material from which diaphragm 40 is made, which elastic deformation of material requires a comparatively higher threshold pressure than is required to change the shape of cup 54. Thus, while the use of zero convolutions may maximize the pressure-sensitive surface area available for pressure to act against, the advantages provided by the more pressure-sensitive triggering mechanism (i.e. the inversion of cup 54) are not present for a flat diaphragm. Thus, an increased sensitivity of diaphragm 40 of a given diameter 25 may be achieved through providing a single convolution, as illustrated.

In the illustrated embodiment, the amount that diaphragm 40 can move in response to a pressure rise in transformer 16 is primarily a function of height 57. Specifically, the notional stroke length available for movement of diaphragm 40 is twice the value of height 57, i.e. the available stroke length if the base of cup 54 fully inverts. In practice, the displacement of the base of cup 54 during a rapid pressure rise is approximately half the stroke length, which corresponds to a displacement just slightly less than height 57. A desirably high stroke length is advantageous as it decreases the possibility of a false triggering of actuator mechanism 30. The convolution provided by annular ridge 53 allows for a larger height 57 and thus, stroke distance, than would a corresponding flat diaphragm.

While a diaphragm 40 having a generally circular shape is illustrated and described, diaphragm 40 could have other shapes (e.g. triangular, square, rectangular, or other polygonal or asymmetrical shape), provided that the corresponding components with which diaphragm 40 must be engaged are provided with a corresponding shape. A generally circular shape of diaphragm 40 may be more sensitive than other shapes.

Diaphragm 40 is preferably constructed from a suitably resilient material of a thickness and flexibility to provide a detectable movement to activate actuator mechanism in response to a rapid pressure rise, as described herein. In some embodiments, diaphragm 40 is formed from a malleable or liquid material molded into the final shape of diaphragm 40. The material for diaphragm 40 may be selected for its suitability to being molded by manufacturing processes such as injection molding, compression molding, transfer molding, or the like. In some embodiments, the manufacture of diaphragm 40 comprises first forming a suitable material into the desired shape of diaphragm 40 and then curing the material by any suitable means.

Diaphragm 40 undergoes large scale non-elastic motion in response to the pressure differential generated by a rapid pressure rise. Diaphragm 40 is designed to have maximum lateral movement with minimal elastic deformation of the material from which diaphragm 40 is made. Diaphragm 40 is preferably made from a material which is flexible or stretchy, but which does not easily undergo elastic deformation. In contrast, the overall shape of diaphragm 40 is designed to be elastic, to allow for deformation of said shape upon the occurrence of a rapid pressure rise. Without being bound by theory, elastic deformation of the material from which diaphragm 40 is made does not cause large scale translational motion (i.e. deflection) of diaphragm 40 and therefore lowers the sensitivity of actuator mechanism 30. It is the vertical deflection of diaphragm 40 itself via the compression of cup 54 to move trigger pin 50 that results in activation of internal fault detector 22.

The material from which diaphragm 40 is made is also preferably resilient to high temperatures and does not degrade when exposed to a variety of types of fluids, e.g. mineral oil or ester-based fluids, or electrically insulating gas that may be used in an electrical device.

In some embodiments, the material used to form diaphragm 40 is an elastomer. The elastomer may be a thermosetting polymer. According to a more specific embodiment, the material used to form diaphragm 40 is fluorosilicone rubber (FVMQ). In other embodiments, the material used to form diaphragm 40 may be a nitrile, a fluoroelastomer, a fluorocarbon, or neoprene. In some embodiments, diaphragm 40 is formed from a composite material having embedded fibers. In some embodiments, the embedded fibers are polymer fibers. In some embodiments, the embedded fibers, including the embedded polymer fibers, are embedded only on one surface of diaphragm 40. In some embodiments, the embedded fibers, including the embedded polymer fibers, are embedded on both surfaces of diaphragm 40. Use of polymer fibers may advantageously increase the toughness of diaphragm 40 while allowing it to remain compliant. In some embodiments, the material used to form diaphragm 40 is a fiber-embedded fluorosilicone.

In some embodiments, diaphragm 40 (excluding lip 51) may have a thickness of 0.005 to 0.02 inches, including any value therebetween, e.g. 0.01 or 0.015 inches. According to a more specific embodiment, diaphragm 40 has a thickness of around 0.012 inches. In some embodiments, the material from which diaphragm 40 is made may have a hardness in the range of 50-95 shore A durometer, including any value therebetween, e.g. 52, 54, 56, 58, 60, 62, 64, 66, 68, 70, 72, 74, 76, 78, 80, 82, 84, 86, 88, 90, 92 or 94 shore A durometer. In one specific example, the material from which diaphragm 40 is made has a hardness of approximately 71 shore A durometer. The material used to form diaphragm 40 is preferably resilient to high strains for when a rapid pressure rise within housing 20 forces diaphragm 40 upwards.

In addition to the material from which diaphragm 40 is made, the shape and configuration of diaphragm 40 also affects the ease with which diaphragm 40 can be actuated. As an example, the illustrated configuration of diaphragm 40 has been found to provide good sensitivity to the occurrence of faults while being suitably resilient to tearing. In some applications, an increased sensitivity of diaphragm 40 (and thus an increased sensitivity of actuator mechanism 30) to pressure differentials is desirable. For example, a more compliant diaphragm 40 allows for the construction of a smaller actuator mechanism than would be the case if diaphragm 40 were comparatively uncompliant. Upward forces produced by a pressure differential across diaphragm 40 acts against a downward reaction spring force produced by diaphragm 40, which biases diaphragm 40 toward its initial position. Additionally, downward forces produced by the weight of support wheel 35, spindle 31, and trigger pin 50, to which diaphragm 40 is attached, must be overcome in order for actuator mechanism 30 to trigger. In some embodiments, a spring can be integrally formed with or biased against diaphragm 40, to supply further downward forces that must be overcome for diaphragm 40 to trigger actuator mechanism 30. As later discussed herein, a horizontal force produced by a spring 70, part of indicator mechanism 32 and acting on trigger pin 50, asymmetrically biases the positioning of diaphragm 40 if not otherwise limited as via some embodiments described further herein, thereby increasing the pressure required to trigger actuator mechanism 30.

The inventors have determined that the spring constant of diaphragm 40 provides a representative indication of the ease with which diaphragm 40 can be actuated, with a lower spring constant k translating into an actuator that can be activated by a lower rise in pressure within the housing of the electrical device. A low spring constant for diaphragm 40 may be achieved in the illustrated configuration by the combination of the geometry and selected material of diaphragm 40. Prior art diaphragms employed in devices for detecting rapid pressure rises within electrical devices, such as in Patent Cooperation Treaty publication No. WO 2011/153604, may have a spring constant of about 7 lbs/in. In comparison, in some example embodiments, diaphragm 40 of the present invention may have a spring constant of about 1.7 lbs/in or less. In some embodiments, diaphragm 40 of the present invention has a spring constant in the range of about 1 to about 5 lbs/in, including any value therebetween, e.g. 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5 lbs/in.

In some embodiments, a light compression spring is provided over top of diaphragm within chamber 36. This has the effect of biasing diaphragm 40 downwards and makes actuator mechanism 30 relatively more insensitive to pressure changes within housing 20. A relatively more insensitive actuator mechanism 30 may be desirable in circumstances where false positive activations of internal fault detector 22 are costly, for example, where transformer 16 is located in a relatively inaccessible location.

In the illustrated embodiment of FIGS. 5A-5B, diaphragm 40 is a preconvoluted diaphragm, that is, the convolution provided by annular ridge 53 is formed in diaphragm 40 as manufactured. In alternative embodiments, the annular ridge is formed in a diaphragm having a top hat configuration as shown in cross-section in FIG. 5C either during assembly or during activation as is known in the art. A top hat diaphragm 40A has a lip 51A that allows diaphragm 40A to be secured within chamber 36 and a downwardly depending cup 54A (shown in solid lines in FIG. 5C) positioned radially inwardly of lip 51A. Manually during installation or by virtue of the forces applied against the base of cup 54A during a transient pressure surge, downwardly depending cup 54A can take on a configuration as shown in dashed lines in FIG. 5C, forming a convolution defined by annular ridge 53A. Thus, in some embodiments, the single convolution in the diaphragm is present during only a portion of the activation process.

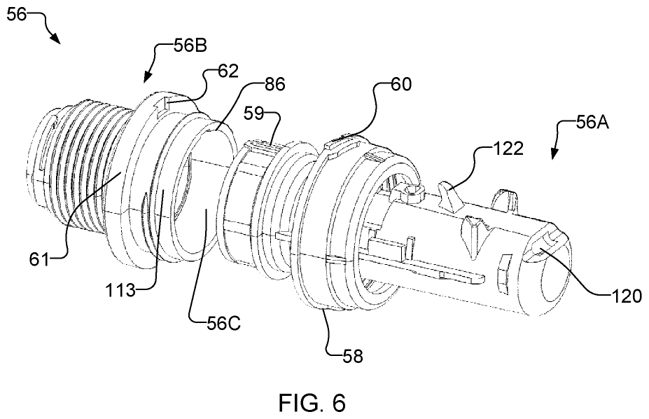

FIG. 6 shows barrel 56, which is a part of indicator mechanism 32. In the illustrated embodiment, barrel 56 has two separate portions, inner portion 56A and outer portion 56B. Outer portion 56B is the portion of barrel 56 which passes through housing 20. Outer portion 56B may be coupled to inner portion 56A in any suitable manner. In the illustrated embodiment, outer portion 56B comprises a receiving slot 86. Inner portion 56A comprises a corresponding key 59, which is received by slot 86 when indicator mechanism 32 is assembled. Assembly of barrel 56 using the illustrated configuration ensures that relative rotation between portions 56A and 56B is prevented. Any other mechanism suitable for preventing relative rotation of portions 56A and 56B when installed may be employed. Once portions 56A and 56B are engaged, a threaded collar 58 may engage with corresponding outer threads provided on outer rearward extension 113 of outer portion 56B. Collar 58, when installed within internal fault detector 22, serves to retain portions 56A and 56B in the assembled configuration of barrel 56.

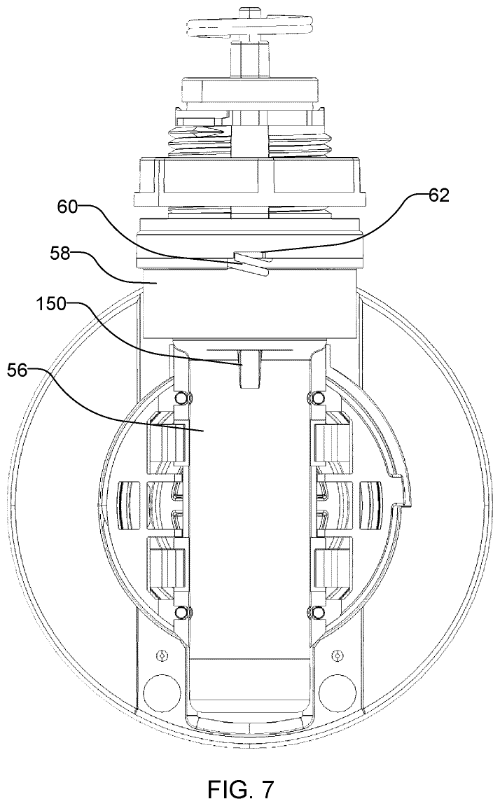

Barrel 56 may be provided with an anti-rotation element such as locking tab 60 shown in FIG. 7. Locking tab 60 engages with locking slot 62 to further prevent relative rotation of inner and outer portions 56A and 56B and to prevent accidental disengagement of collar 58. To separate inner and outer portions 56A and 56B, a user may depress locking tab 60 away from slot 62, thereby permitting collar 58 to be disengaged by unthreading collar 58 from outer portion 56B. One or more apertures may preferably be provided through the lower surface of barrel 56 to facilitate drainage of any fluid therefrom. In the illustrated embodiment, a drainage aperture 150 is provided on inner portion 56A of barrel 56.

Outer portion 56B of barrel 56 projects through aperture 24 and includes an outer flange 61. As best shown in FIG. 3, an all-weather gasket 63 interposes a nut 65 threaded onto an outer threaded shoulder 69 of outer portion 56B and outer flange 61. Nut 65 is tightened against the exterior wall surface of housing 20 to ensure the integrity of the seal around aperture 24. When nut 65 is tightened, gasket 63 presses against the interior wall of housing 20, thereby sealing the interior of housing 20 against the exterior environment. Nut 65 may also be provided with a collared shoulder 67 to provide a greater surface area for engaging housing 20 and to prevent internal fault detector 22 from sliding within or through aperture 24.

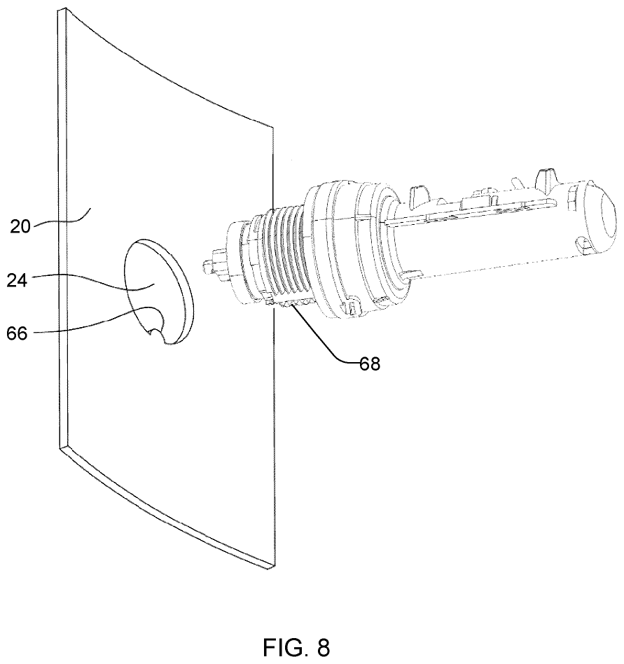

In some embodiments, barrel 56 is prevented from rotating in aperture 24. This may be accomplished, for example, by providing a projection 66 in aperture 24, which engages a corresponding notch 68 in outer portion 56B (see FIG. 8). Increasing the depth of notch 68 and the size of projection 66 can provide for more reliable insertion and retention of internal fault detector 22 into housing 20.

Preferably in embodiments intended to be mounted within housing 20, barrel 56 is small enough to fit into aperture 24 which may be approximately 1.35 inches (34 mm) in diameter. Barrel 56 is made of non-conductive material so that barrel 56 does not provide a conductive path through the wall of housing 20. Barrel 56 may, for example, be fabricated from fiber-reinforced polypropylene with additives to provide resistance to degradation by the action of sunlight and/or to improve flammability properties. For example, polybutylene terephthalate, optionally with glass-fiber reinforcement, in combination with suitable additives, may be used.

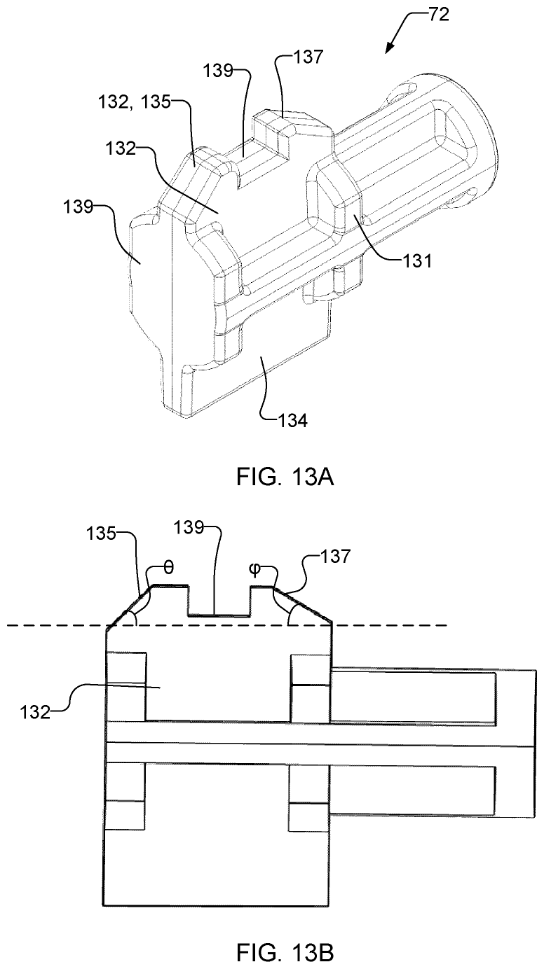

A plunger 64 is located within a bore 56C of barrel 56. Plunger 64 is urged forwardly relative to housing 20 in any suitable manner. For example, in the illustrated embodiment, eject spring 70, shown as a compression spring, is compressed between a receiving cavity 71 within inner end 64A of plunger 64 and a flanged surface 131 of shuttle 72 (see FIGS. 2 and 13A). The eject spring could alternatively be an extension spring arranged to pull plunger 64 forward in bore 56C in place of the illustrated compression spring, or any other suitable type of spring or biasing member. In the illustrated embodiment, inner end 64A and outer end 64B of plunger 64 may be coupled together by the engaging corresponding threads. In alternative embodiments, plunger 64 is formed as a single unit.

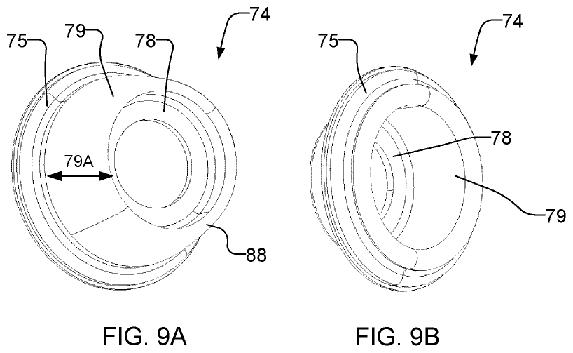

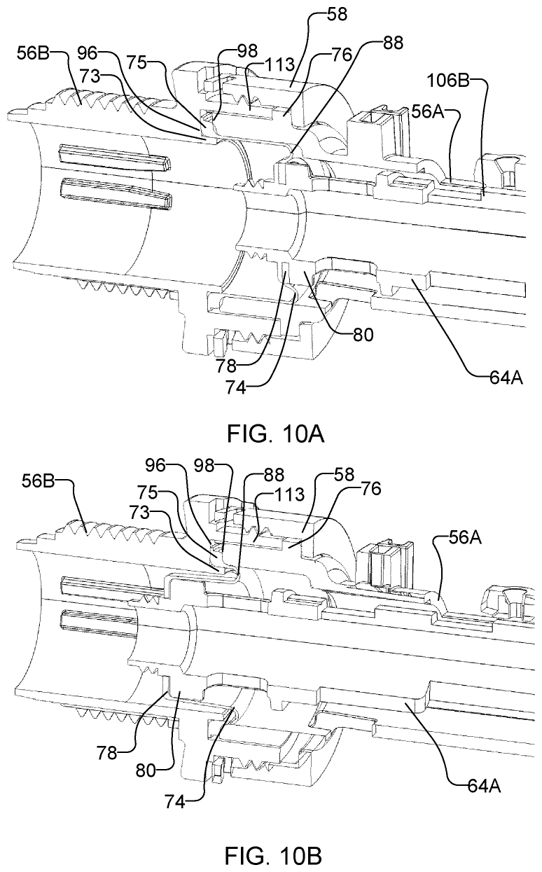

Barrel 56 includes structural features that sealingly engage a seal 74 (FIGS. 9A to 10B) that is also in sealing engagement with plunger 64. Seal 74 is a static seal that engages in fixed relation at a first end with plunger 64 and at a second end with barrel 56 to maintain a seal between the interior of housing 20 and the external atmosphere regardless of whether internal fault detector 22 is in an armed (i.e. unactivated) state or a triggered (i.e. activated) state. A flexible central region of seal 74, in the illustrated embodiment provided by conical wall 79, is long enough and flexible enough to move freely between the unactivated and activated positions, to maintain the seal between barrel 56 and plunger 64 at all times prior to, during and after activation of internal fault detector 22.

Maintenance of a seal between the interior of housing 20 and the external atmosphere as aforesaid assists in ensuring that fluid remains contained inside of housing 20, while external elements such as moisture and dust are not permitted to enter housing 20. By maintaining a stationary sealing surface on both barrel 56 and plunger 64, the sealing achieved by seal 74 is independent of relative axial motion between barrel 56 and plunger 64 when plunger 64 moves between the unactivated and activated states of internal fault detector 22, as illustrated in FIGS. 10A and 10B, respectively.

FIGS. 9A and 9B show an example seal 74 in an unactivated configuration and an activated configuration, respectively, according to an example embodiment of the invention. In some embodiments, seal 74 is a static seal. In the illustrated embodiment, seal 74 is a rolling seal with two ends that remain fixed in position in sealing engagement against corresponding portions of the barrel 56 and plunger 64, respectively while a central portion, in the illustrated embodiment conical wall 79, of seal 74 allows relative movement between these two components. When seal 74 is positioned within internal fault detector 22, seal 74 comprises a sealing lip 75 at a first end thereof which is in constant contact with interfacing inner surface 98 of inner portion 56A and interfacing inner surface 96 of outer portion 56B as best shown in FIGS. 10A and 10B and described below, to maintain a sealed engagement with barrel 56 at all times during the operation of internal fault detector 22. Likewise, a circular surface 78 at the second end of seal 74 is in sealing engagement with a flange 80 provided on inner portion 64A of plunger 64. In conjunction with outer rearward extension 113, an inner rearward extension 73 may be provided radially interiorly of sealing lip 75 on outer portion 56B to maintain a radial position of sealing lip 75 relative to barrel 56. The sealing engagement between seal 74 and both barrel 56 and plunger 64 provides sealing between the interior of housing 20 and the external atmosphere, regardless of whether internal fault detector 22 is in the unactivated or activated configuration.

The first and second ends of seal 74 are joined by a flexible length of material that in the illustrated embodiment forms a conical wall 79. In the illustrated embodiment, sealing lip 75 extends radially outwardly from conical wall 79 at the first end of seal 74. At its second end, seal 74 features an annular ridge 88 before extending radially inwardly to form a generally circular sealing surface 78.

Seal 74 may be formed from any suitably resilient and flexible material. For example, in some embodiments seal 74 is formed from an elastomer. The elastomer may be a thermosetting polymer. According to a more specific embodiment, the material used to seal 74 is fluorosilicone rubber (e.g. FVMQ). In other embodiments, the material used to form seal 74 may be a nitrile, a fluoroelastomer, a fluorocarbon, or neoprene. In some embodiments, seal 74 is formed from a composite material having embedded fibers. In some embodiments, the embedded fibers are polymer fibers. In some embodiments, the polymer fibers are embedded only on one surface of seal 74. In some embodiments, the polymer fibers are embedded on both surfaces of seal 74. Use of polymer fibers may advantageously increase the toughness of seal 74 while allowing it to remain compliant. In some embodiments, the material used to form seal 74 is a fiber-embedded fluorosilicone. In some embodiments, seal 74 is constructed from the same material as diaphragm 40 as previously discussed herein.

The hardness (i.e. durometer) of the material from which seal 74 is made may be selected to ensure that a seal is maintained through the range of normally expected operating conditions of internal fault detector 22. While the material should be selected to be sufficiently flexible so as to ensure that conical wall 79 can freely move during activation, the material used should not be overly elastic, so as to increase the force needed to eject plunger 64. Characteristics of the friction, flex, and profile provided by seal 74 can be varied by the type of material used to construct seal 74. In some embodiments, seal 74 may have a hardness in the range of 50-95 shore A durometer, including any value therebetween, e.g. 52, 54, 56, 58, 60, 62, 64, 66, 68, 70, 72, 74, 76, 78, 80, 82, 84, 86, 88, 90, 92 or 94 shore A durometer. Seal 74 should be made from a material capable of sealing in a variety of types of fluids, e.g. mineral oil or ester-based fluids, or electrically insulating gas that may be used in an electrical device, and at high operating temperatures. In some embodiments, seal 74 (excluding lip 75) may have a thickness of 0.005 to 0.02 inches, including any value therebetween, e.g. 0.006, 0.007, 0.008, 0.009, 0.010, 0.012, 0.014, 0.016, or 0.018 inches. According to a more specific embodiment, seal 74 has a thickness of around 0.017 inches.

During the transition of internal fault detector 22 from the unactivated to the activated configuration, flange 80 of inner end 64A of plunger 64 abuts against and applies an forward force (toward outer portion 56B) on second end 78 of seal 74. Movement of plunger 64 in the forward direction has the effect of inverting the flexible conical wall 79 of seal 74 into the configuration shown in FIG. 9B, with conical wall 79 rolling past itself and second end 78 moving forwardly past sealing lip 75 in the illustrated embodiment. Due to the seal created by the stationary compression of lip 75 and the construction of seal 74 from a flexible material in the illustrated embodiment, plunger 64 is permitted to move freely during operation without any loss in sealing efficacy.

Conical wall 79 has a height 79A defined by the distance between lip 75 and annular ridge 88. In the illustrated embodiment, when seal 74 inverts due to forward motion of plunger 64, plunger 64 may move a distance corresponding to approximately two times the height 79A before seal 74 becomes fully inverted and applies a reaction spring force against the force exerted by spring 70, effectively neutralizing forces in both axial directions.

Because seal 74 does not slide with respect to either barrel 56 or plunger 64, the amount of friction that needs to be overcome to move plunger 64 relative to barrel 56 is reduced as compared with prior designs that maintained a sliding frictional engagement between the seal and the plunger.

Some embodiments of the present invention provide a means for decoupling an indicator mechanism (e.g. indicator mechanism 32) from an actuator mechanism (e.g. actuator mechanism 30), both mechanisms being part of an internal fault detector. Preferably, this decoupling transfers any externally induced motion or forces on the indicator mechanism to a wall of the electrical device in which the internal fault detector is installed, rather than to actuator mechanism 30. The means for decoupling the indicator mechanism from the actuator mechanism comprises a locking mechanism that engages with the indicator mechanism, to transfer forces encountered by the indicator mechanism to a component other than the actuator mechanism, e.g. the wall of the electrical device via other components of the internal fault detector.

In one exemplary embodiment, the means for decoupling further comprises an intermediate component which interfaces with both the indicator mechanism and the actuator mechanism. The intermediate component is biased in a forward direction (i.e. toward the triggered position) and only upon triggering of the actuator mechanism, moves in a forward direction to disengage the locking mechanism, wherein disengagement of the locking mechanism permits free movement of the indicator mechanism in an axially forward direction. Optionally, the locking mechanism may be re-engaged shortly after the internal fault detector has triggered to restrict further motion of the indicator mechanism, e.g. in an axially rearward direction and/or complete ejection in the forward direction.

In the illustrated embodiment, the means for decoupling the indicator mechanism from the actuator mechanism is a lock bar 110 that interacts with a shuttle 72, and acts as an interface to effectively decouple indicator mechanism 32 from actuator mechanism 30 as compared with prior designs. More specifically, indicator mechanism 32 is decoupled from actuator mechanism 30 because any forces applied on indicator mechanism 32, e.g. by a user installing internal fault detector 22 or by a user pulling on pull ring 107, are not transferred to trigger pin 50 and thus to actuator mechanism 30. The only forces that affect the deployment of actuator mechanism 30 are those forces associated with the various components of actuator mechanism 30 and the biasing force against trigger pin 50 by spring 70. Shuttle 72 serves as an intermediate component which interfaces with both the indicator mechanism 32 and actuator mechanism 30. Specifically, upon the triggering of actuator mechanism 30, shuttle 72 moves in a forward direction to disengage lock bar 110 to thereby permit free movement of indicator mechanism 32. This allows the design of actuator mechanism 30 to be optimized without having to account for such additional forces as may be contributed by indicator mechanism 32 if indicator mechanism 32 were not decoupled from actuator mechanism 30, for example as in prior devices.

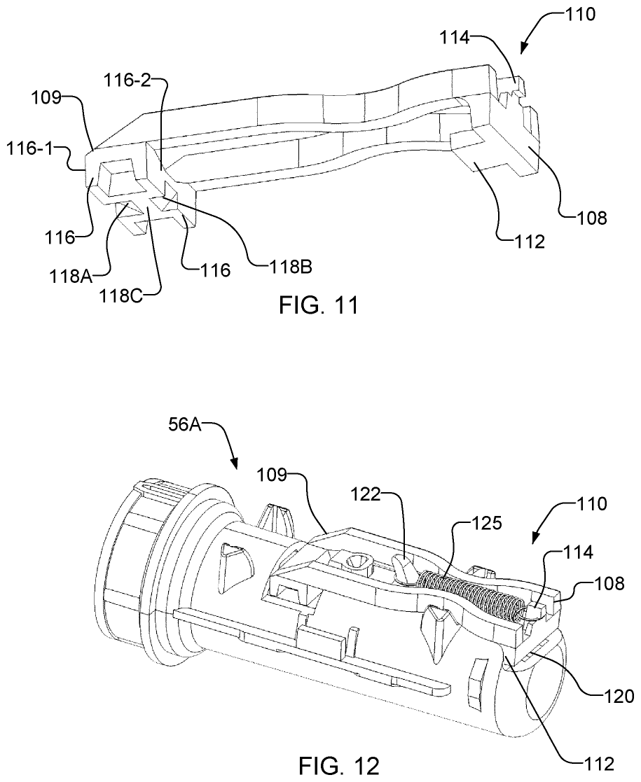

In some embodiments, lock bar 110 can also help to ensure that internal fault detector 22 is not improperly interfered with when in either the unactivated or activated configurations. As shown in FIG. 11, lock bar 110 has an rearwardly extending catch 112 at the end of a downward extension at a first longitudinal end 108 of lock bar 110. Proximate to first longitudinal end 108, lock bar 110 has an upwardly extending hook 114. At an opposite second longitudinal end 109 of lock bar 110, lock bar 110 has two pairs of downwardly extending arms 116 located on opposite transverse sides of lock bar 110. Ramped surfaces 118A and 118B are disposed transversely between the two pairs of arms 116. Ramped surface 118A is provided on a forward edge of second longitudinal end 109, and slopes upwardly and forwardly from a midpoint 118C between ramped surfaces 118A and 118B. Ramped surface 118B is provided on a rearward edge of second longitudinal end 109, and slopes upwardly and rearwardly from midpoint 118C.

FIG. 12 shows the installation of lock bar 110 onto inner portion 56A of barrel 56. Inner portion 56A comprises a slot 120 (also visible in FIG. 6) for receiving catch 112 of lock bar 110. Inner portion 56A further comprises an upwardly extending beveled protrusion 122 longitudinally spaced from groove 120. To install lock bar 110 onto inner portion 56A in the illustrated embodiment, catch 112 is placed within slot 120 while second end 109 of lock bar 110 is pivoted at an upward angle relative to inner portion 56A of barrel 56. Second end 109 of lock bar 110 is then pivoted downward into its secured position, resulting in the configuration shown in FIG. 12 in the unactivated position. In this configuration, lock bar 110 is pivotally coupled to inner portion 56A of barrel 56 at first end 108, so that second end 109 can be displaced upwardly in the vertical direction by shuttle 72 as described below.

In some embodiments, including the illustrated embodiment, lock bar 110 is also slideably engaged with inner portion 56A of barrel 56, to allow for longitudinal movement of lock bar 110, i.e. in the forward and rearward directions. Embodiments of lock bar 110 that are slideably and pivotally engaged with inner portion 56A may be used in conjunction with a shipping lock to further secure detector 22 against activation during shipping as described below. To achieve this slideable and rotatable engagement of lock bar 110 in the illustrated embodiment, catch 112 of lock bar 110 is sufficiently elongated to remain secured within slot 120 even while lock bar 110 is displaced in the rearward direction by shipping lock 90 as described below, and also permits rotation of lock bar 110 to allow second end 109 to be upwardly displaced by shuttle 72 as described below.

In the illustrated embodiment, opposite ends of a retaining spring 125 (shown as an extension spring in the illustrated embodiment) are secured around each of protrusion 122 and hook 114 to retain catch 112 in groove 120, thereby preventing significant relative axial movement between lock bar 110 and inner portion 56A. In embodiments in which lock bar 110 is both slideably and rotatably engaged with inner portion 56A, retaining spring 125 should be selected to permit a sufficient degree of rearward displacement of lock bar 110 relative to inner portion 56A to allow lock bar 110 to engage with catch 162 as described below. Retaining spring 125 also exerts a downward force on second end 109 of lock bar 110, to help hold locking arms 116 in position to restrain movement of plunger 64 as described below.

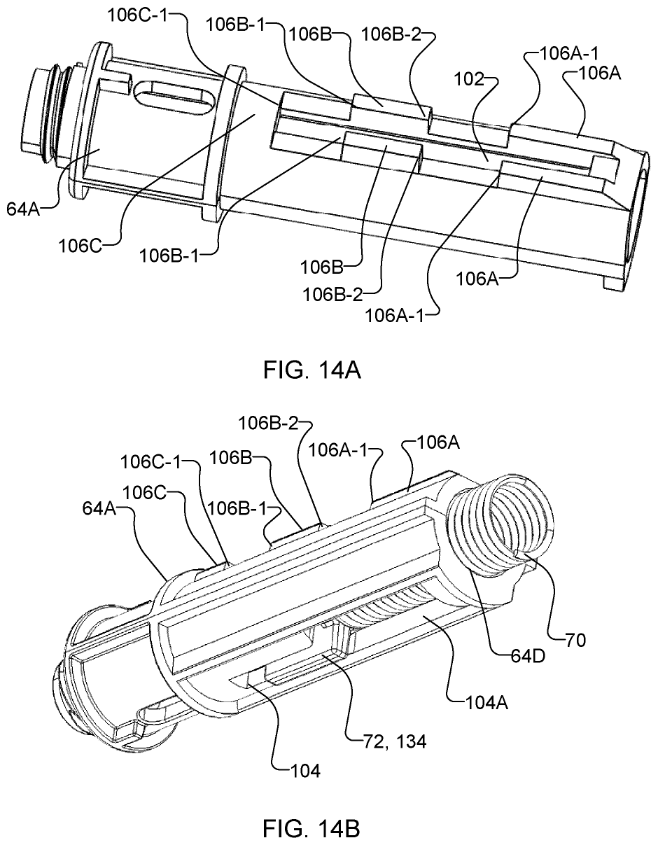

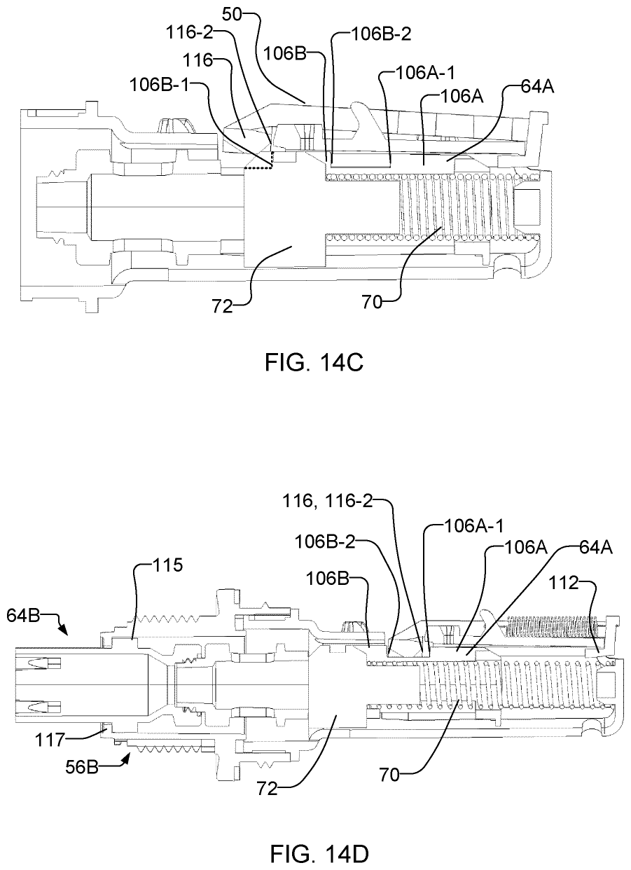

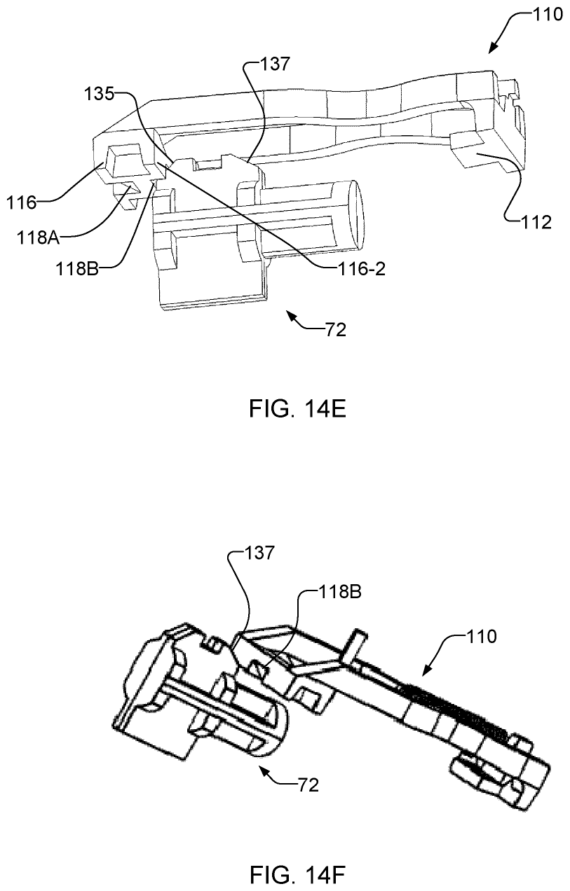

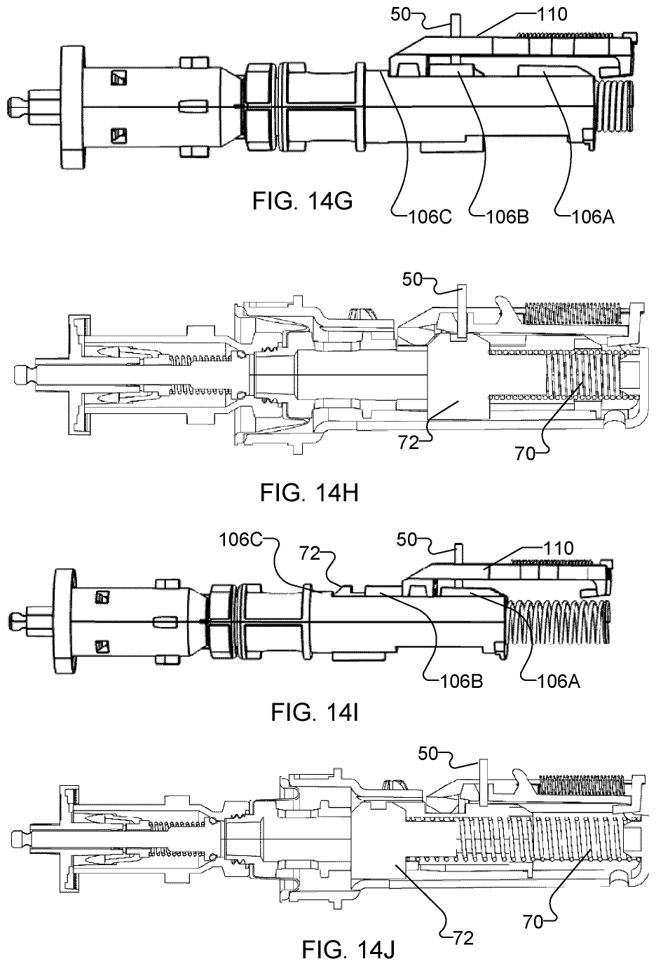

Shuttle 72 (see FIGS. 13A, 13B, 14B, 14C and 14D) is provided in the illustrated embodiment to serve as an interface between actuator mechanism 30 and indicator mechanism 32. As best seen in FIG. 2, in the unactivated configuration, trigger pin 50 sits within trigger notch 139 of shuttle 72. Once actuator mechanism 30 is actuated by a rapid pressure rise, trigger pin 50 moves upwardly in the illustrated embodiment out of trigger notch 139 to release shuttle 72 under the force applied by spring 70. This permits spring 70 to release its potential energy to push shuttle 72 forward, wherein the forward motion releases lock bar 110, permitting indicator mechanism 32 to enter the activated configuration as explained below.

As best shown in FIG. 2, shuttle 72 is disposed primarily radially interiorly of inner end 64A of plunger 64. Inner end 64A comprises upper and lower slots 102 and 104, which receive upper and lower portions 132 and 134 of shuttle 72, respectively, to permit relative axial movement between plunger 64 and shuttle 72 while preventing relative rotation (see FIG. 14B). FIGS. 13A and 13B show an example embodiment of a shuttle 72. Shuttle 72 comprises a flanged surface 131 for the engagement with one end of eject spring 70. On upper portion 132, shuttle 72 additionally comprises front and rear ramped surfaces 135 and 137 and a trigger notch 139 interposed therebetween. Front ramped surface 135 ramps generally upwardly at a smooth angle from front to back, while rear ramped surface 137 ramps generally downwardly at a smooth angle from front to back.

As best seen in FIG. 13B, in some embodiments, including the illustrated embodiment, front and rear ramped surfaces 135, 137 can be provided with different angles. For example, in the illustrated embodiment, front ramped surface 135 has a steeper angle 9, of approximately 45 degrees from horizontal, than does rear ramped surface 137, which has an angle 9 of approximately 30 degrees from horizontal. The angles of ramped surfaces 118B and 118A on lock bar 110 are selected to be complementary to the angles used for front and rear ramped surfaces 135, 137, respectively, to facilitate smooth movement of lock bar 110 by shuttle 72. The use of different values for angles A and 9 may allow for movement of shuttle 72 from the unactivated configuration into the activated configuration to take place relatively more easily than the movement of shuttle 72 from the activated configuration to the unactivated configuration, e.g. as would be done when resetting internal fault detector 22. Also, lock bar 110 is constrained against movement in the forward direction via engagement of its first longitudinal end 108 against inner portion 56A of barrel 56 (with catch 112 engaged in slot 120). However, lock bar 110 is constrained against movement in the rearward direction by spring 125. It is therefore desirable to minimize the level of rearward force applied against lock bar 110 via rear ramped surface 137 of shuttle 72, which can be achieved by minimizing angle φ. However, decreasing angle φ requires increasing the axial length of rear ramped surface 137, and so a balance is sought to avoid making rear ramped surface 137 too long.

Reasonable ranges of values for angle φ include about 25° to about 45°, including any value therebetween e.g. 30°, 35° or 40°. Typically angle θ would be approximately 45°, although other values could be used if desired e.g. 40° or 50° or any value therebetween. Correspondingly, complementary angles for ramped surfaces 118B and 118A can range from between about 45° to about 65° including any value therebetween, e.g. 50°, 55° or 60° and from between about 40° to 50° or any value therebetween including 45°, respectively. Such values are exemplary only and are not limiting as other values may work.

Until internal fault detector 22 is triggered, plunger 64 is prevented from being ejected from barrel 56 by the engagement of trigger pin 50 in trigger notch 139 of shuttle 72 (which secures shuttle 72 against longitudinal movement in the forward direction, preventing shuttle 72 from releasing lock bar 110, and prevents shuttle 72 from transferring the biasing force applied by eject spring 70 to plunger 64 to any significant extent) and by the engagement of lock bar 110 with retaining surfaces on plunger 64 as described below. Trigger pin 50 passes into bore 56C of barrel 56 through a chamfered guide opening 77 (see FIG. 2). Diaphragm 40 may provide a slight downward force which tends to seat trigger pin 50 in trigger notch 139. Upon the occurrence of a rapid pressure rise, diaphragm 40 actuates trigger pin 50 upwardly out of engagement with trigger notch 139, thereby permitting eject spring 70 to extend in length and force shuttle 72 forward (toward outer portion 56B) by displacing lock bar 110 as described below.

Referring to FIGS. 14A and 14B, inner end 64A of plunger 64 comprises inner and outer upward protrusions 106A and 106B along a longitudinal length of slot 102. Protrusions 106A and 106B provide locking members that can engage with lock bar 110 to restrain movement of plunger 64. Under regular operating conditions of transformer 16, plunger 64 is prevented from forward movement by the engagement of a forward facing surface 106B-1 of protrusion 106B with a rearward facing surface 116-2 of arms 116 of lock bar 110 when lock bar 110 is in its locked configuration. Likewise, rearward motion of plunger 64 (e.g. as might be caused by a user pressing on plunger 64 externally) is prevented by the engagement of a rearward facing surface 106C-1 of a third protrusion 106C on plunger 64 (best seen in FIG. 14B) with a forward facing surface 116-1 of arms 116 of lock bar 110.

When shuttle 72 is forced forward, ramped surface 135 of shuttle 72 engages with ramped surface 118B of lock bar 110 (interaction best seen in FIG. 14C). Continued forward motion of shuttle 72 following such engagement causes second longitudinal end 109 of lock bar 110 to pivot upward to a release configuration as ramped surface 135 of shuttle 72 slides relative to ramped surface 118B of lock bar 110, rotating lock bar 110 about catch 112 (shown in FIG. 14D). The upward pivoting of second longitudinal end 109 of lock bar 110 disengages mating surfaces 106B-1 of wall 106B and arms 116. This permits plunger 64 to be moved forward through the action of spring 70 (acting on shuttle 72 in the illustrated embodiment). In the illustrated embodiment, shuttle 72 is disposed between the opposing pairs of arms 116, between the width of ramps 118A and 118B. Therefore, shuttle 72 is not restricted from motion by arms 116 and protrusions 106A and 106B and may move freely to disengage lock bar 110 as described herein, as shown in FIGS. 14E and 14F.

When positioned within indicator mechanism 32, retaining spring 125 biases lock bar 110 in a horizontal configuration as shown in FIG. 12. After plunger 64 has advanced a certain distance, ramped surface 137 of shuttle 72 slides past ramped surface 118A of lock bar 110, allowing second longitudinal end 109 of lock bar 110 to pivot back downwardly about catch 112, allowing arms 116 of lock bar 110 to be seated in a depression defined by protrusions 106A and 106B, so that lock bar 110 is returned to a second locked configuration. This motion is facilitated by the downward aspect of the force applied on lock bar 110 by retaining spring 125. As shown in FIG. 14D, the rearward facing surface 116-2 of arms 116 engages with a forward facing surface 106A-1 of protrusion 106A to block further advancement of plunger 64, thereby preventing complete ejection of plunger 64 from internal fault detector 22. As an additional or alternative measure for preventing complete ejection of plunger 64, outer end 64B of plunger 64 comprises an outwardly directed flange 115 which comes into contact with an inwardly directed flange 117 of outer portion 56B of barrel 56, thereby preventing further forward axial motion of plunger 64.

The illustrated embodiment decouples indicator mechanism 32 from actuator mechanism 30. Should any forces be applied against plunger 64 by a person pulling or pushing on ring 107 when internal fault detector 22 is in the unactivated configuration, the engagement of arms 116 of lock bar 110 against surfaces of plunger 64 (e.g. forward facing surface 106B-2 of protrusion 106B and rearward facing surface 106C-1 of protrusion 106C) prevents motion of plunger 64, which in turn prevents plunger 64 from exerting force on trigger pin 50 via shuttle 72 and thereby interfering with actuator mechanism 30. Through the coupling of lock bar 110 to barrel 56, such forces applied against plunger 64 are borne by barrel 56, and can be transferred e.g. to the walls of the electrical device in which internal fault detector 22 is installed. In some embodiments, indicator mechanism 32 supports externally applied forces of 120 pound-force or more in either axial direction. An example benefit of such a configuration is that design considerations involving the capability of trigger pin 50 to bear axially directed forces can be determined solely by the expected force that spring 70 applies on trigger pin 50 by way of shuttle 72, rather than needing to account for any additional externally-applied forces that could potentially be applied via plunger 64.

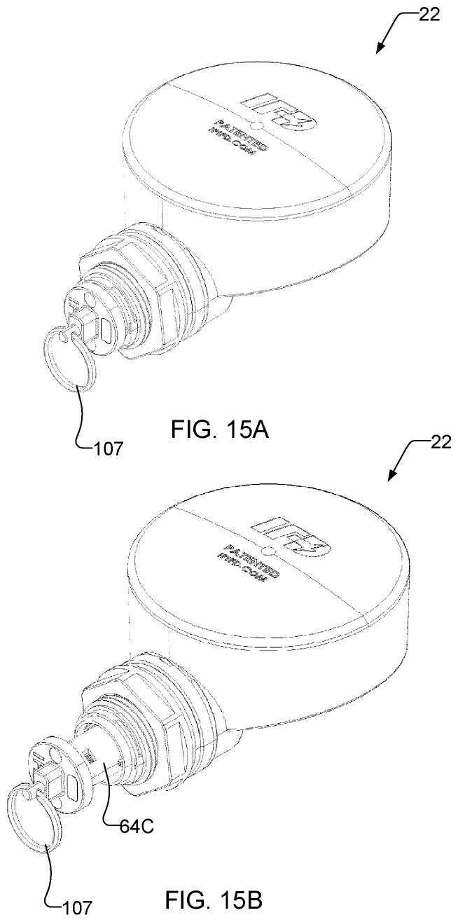

FIG. 15A shows internal fault detector 22 in the unactivated state, while FIG. 15B shows internal fault detector 22 in the activated state. Preferably, after plunger 64 has been pushed forward in bore 56C, the outer end of plunger 64 extends significantly beyond the outer opening of barrel 56. This provides a highly visible indication that a fault has occurred in transformer 16. The shape of internal fault detector 22 is thus changed after plunger 64 has been ejected. Furthermore, the side surface 64C of plunger 64, or a portion thereof, may be brightly coloured, and may have a colour which has high contrast to the colours typically found in the environment of transformer 16. Suitable colours include bright colours such as blaze orange and bright yellow. Thus, after plunger 64 has been ejected, its brightly coloured side surface 64C is exposed to view and is easy to see. Internal fault detector 22 can be mounted in a side wall of housing 20, thereby permitting it to display an indication that an internal fault has occurred in a location which is readily visible.

When internal fault detector 22 is in the triggered configuration, arms 116 may engage with a rearward facing surface 106B-2 of protrusion 106B to block plunger 64 from being pushed back into bore 56C. This prevents transformer 16 from being put unknowingly back into service without having passed an internal inspection. In general, whenever an electrical device has malfunctioned in a way that has triggered internal fault detector 22, the device should be inspected before it is put back into service. Providing an indicator element which cannot be easily returned to its initial position after internal fault detector 22 has been triggered without opening housing 20 reduces the likelihood that, through human error, an electrical device will be placed back into use before it has been properly inspected and serviced. As an alternative, a separate pawl or other one-way ratchet mechanism could be provided so that internal fault detector 22 can be reset only from inside housing 20.

More generally, the operation of lock bar 110 and shuttle 72 can be described as follows. Lock bar 110 provides a pivotable locking member that is pivotable about a first end (108 in the illustrated embodiment) and has a locking edge (116-2 in the illustrated embodiment) at its second end (109) that is ordinarily biased in a first direction (downwardly in the illustrated embodiment) to prevent forward movement of indicator mechanism 32 (e.g. by restraining forward movement of plunger 64 via engagement with protrusion 106B in the illustrated embodiment).

In some embodiments, the pivotable locking member may also restrain rearward movement of indicator mechanism 32 in the unactivated configuration (e.g. via engagement of forward facing surface 116-1 with protrusion 106C in the illustrated embodiment—note that although surfaces 116-1 and 116-2 are provided on separate arms in the illustrated embodiment, in alternative embodiments these surfaces could be provided as opposed surfaces of the same arm).

The pivotable locking member cooperates with a sliding unlocking member (provided by shuttle 72 in the illustrated embodiment), so that when shuttle 72 is released for forward movement by trigger pin 50 being displaced out of engagement with shuttle 72 (e.g. being displaced from trigger notch 139 in the illustrated embodiment), an angled surface of the sliding unlocking member (angled surface 135 in the illustrated embodiment), acts as a wedge to displace the second end (109) of the pivotable locking member in a second direction (upwardly in the illustrated embodiment), to disengage the locking edge (116-2) and release indicator mechanism 32 for forward movement. In some embodiments, including the illustrated embodiment, the sliding unlocking member is provided with a cooperating angled surface (118B in the illustrated embodiment) that is complementary to and slides past angled surface 135 of the sliding unlocking member.

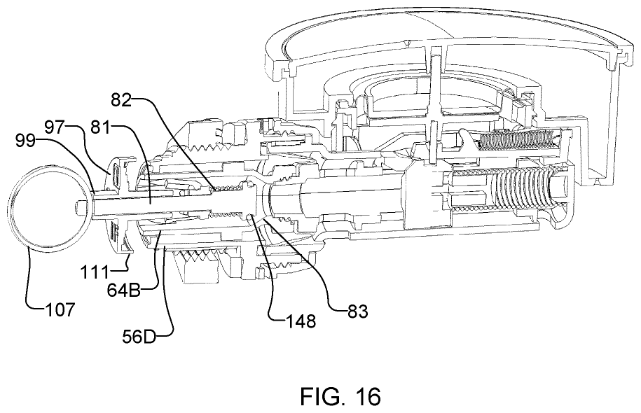

Pressure relief valve 34 may be made integral with plunger 64 and is contained within an outer portion 64B of plunger 64. Pressure relief valve 34 has an axially movable valve member 81 which is biased into engagement with a valve seat 83 by a low rate spring 82. Ordinarily, valve member 81 is sealingly biased against valve seat 83 to maintain a seal between the external atmosphere and the interior of housing 20, thereby preventing moisture ingress into the interior of housing 20. If the ambient pressure within housing 20 exceeds the atmospheric pressure outside of housing 20 then there is a net forward force on the end of valve member 81. When this force exceeds a predetermined value, for example, a force corresponding to a pressure differential of 5 psi, 7 psi, 10 psi, or 12 psi, spring 82 will compress and allow gases to vent from housing 20 through a venting gap 148 (see FIG. 16). The predetermined value at which gases will be permitted to vent may be varied by varying the characteristics of low rate spring 82, for example by varying the length of the uncompressed spring, the number of active turns, wire diameter, inner and outer diameter, or otherwise varying the spring constant thereof. For ease of reference, springs to be used in pressure relief valve 34 may be color coded depending on the range of pressures that will activate a pressure relief valve containing that spring. The venting characteristics of pressure relief valve 34 may also be varied by varying the diameter of the venting gap.

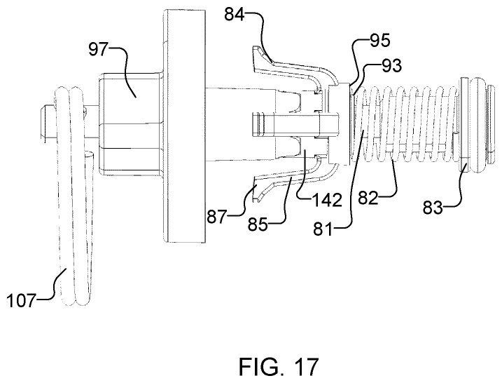

With reference to FIGS. 3 and 17, valve member 81 protrudes through a spring retainer 84. Low rate spring 82 is contained between valve seat 83 and spring retainer 84. In the illustrated embodiment, spring retainer 84 has a generally cylindrical centre portion 142 disposed around valve member 81 and in sliding contact therewith. Four legs 85 extend axially and radially outwardly from centre portion 142 and terminate in feet 87. Feet 87 are engageable with receiving notches 89 (FIG. 3) formed in the body of plunger 64 to thereby secure spring retainer 84 within the bore 64D of plunger 64 and retain low rate spring 82 in compressed engagement with a valve seat 83. The degree to which spring retainer 84 securely holds spring 82 may be adjusted by altering the length and/or width of legs 85 and feet 87. As shown in FIG. 17, a centering feature such as an angled surface 93 may be provided to contact one end of spring 82 to assist in centering spring 82 on a spring contacting surface 95 of spring retainer 84, thus providing more repeatable activation. Alternatively, the centering feature could be a projecting ring or a plurality of projections (not shown) extending axially inwardly from the outer edges of spring surface 95 and positioned to align the outer edges of spring 82 in the desired location.

As valve member 81 moves axially forwardly, gases can escape from housing 20 by way of a venting gap 148 (FIG. 16) between valve member 81 and the outer end 64B of plunger 64. Increasing the size of the venting gap can permit for higher flow. Increasing the length of valve member 81 may allow for easier re-assembly of the pressure relief valve 34 into internal fault detector 22 after activation. A ring or other graspable member 107 may be attached at the outer end of valve member 81 to permit manual venting of housing 20 (i.e. by pulling forwardly on valve member 81). Combining an internal fault detector and a pressure relief valve in a single device avoids the need to provide two apertures in housing 20.

A dust cover 97 may be provided and inserted over pressure relief valve 34 to prevent intrusion of debris or other matter from the external environment into pressure relief valve 34 while still permitting fluid egress. Dust cover 97 may be configured to float in and out to achieve these functions. Dust cover 97 preferably covers both the outer end 64B of plunger 64 and outer end 56D of barrel 56, and may have an outer lip 111 (shown in the embodiment of FIGS. 16 and 17) that extends axially inwardly and overlaps a portion of outer end 56D of barrel 56. Dust cover 97 may include an installation tab 99 on its outer face, which may be oriented vertically or horizontally to assist in distinguishing when pressure relief valve 34 has been properly installed.

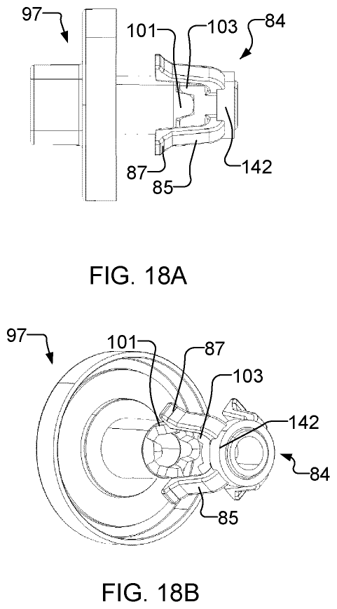

To facilitate installation of pressure relief valve 34 by allowing valve 34 to be rotated until feet 87 of spring retainer 84 engage with receiving notches 89, a plurality of insert tabs 101 (FIG. 18B) may be provided at the inner end of dust cover 97. Insert tabs 101 are dimensioned and positioned to engage with a plurality of corresponding insert tabs 103 provided on the outer edge of centre portion 142 of spring retainer 84. Insert tabs 101 and/or 103 may have rounded edges, as best shown in FIGS. 18A-18B, to prevent pressure relief valve 34 from being easily twisted and thereby snapped free of internal fault detector 22 after pressure relief valve 34 has been installed.

To further assist installation, dust cover 97 may be provided with crosshairs or a mark or other visual indicia to assist in inserting pressure relief valve 34 and dust cover 97 in the correct orientation. Alternatively or additionally, one or more guide channels (not shown) may be formed within bore 64D of plunger 64 to receive and guide feet 87 to receiving notches 89.

To install internal fault detector 22, the exact order of assembly of the component parts is not critical. As best shown in FIG. 14B, slot 104 of inner end 64A may have a wider rearward opening 104A. In one exemplary embodiment to assemble internal fault detector 22, shuttle 72 is inserted into the interior of inner end 64A through the wider opening 104A and then advanced forward until upper and lower portions 132 and 134 are interposed between slots 102 and 104, respectively, to prevent relative rotation. Eject spring 70 may be inserted into inner end 64A through bore 64D so that an end of spring 70 contacts flanged surface 131 of shuttle 72. The assembly of inner portion 64A, shuttle 72 and spring 70 may be slid within bore 56C of inner portion 56A so that eject spring 70 is biased against inner end 56E of barrel 56. Shuttle 72 may be pushed rearwardly toward inner end 56E, thereby compressing spring 70. Trigger pin 50 may be inserted through chamfered guide opening 77 into trigger notch 139 to secure shuttle 72 and plunger 64 in the armed position within barrel 56. In embodiments where trigger pin 50 is fastened to spindle 31 by means of an interference fit, it may be desirable to position spindle 31 and trigger pin 50 concurrently. Lock bar 110 may then be installed as described above to prevent relative axial motion between barrel 56 and plunger 64.

Inner portion 56A may be snapped into groove 91 of splash guard 44 and be retained thereto by resilient outer edges 91A of groove 91 (FIG. 3). Longitudinally extending retaining arms 92 may be provided on the exterior of barrel 56 to better engage with and retain outer edges 91A. When barrel 56 is received in groove 91, groove 91 engages with and grips barrel 56. Seal 74 may be interposed between inner portion 56A and outer portion 56B as the engagement of the two portions of barrel 56 is guided by the positioning of key 59 inside slot 86 (FIG. 6). Collar 58 may then be threaded onto corresponding outer threads on outer rearward extension 113 of outer portion 56B. Upon fully threading collar 58, an inwardly directed flange of collar 58 compresses a flange 76 (FIG. 10A) of inner portion 56A against outer rearward extension 113 of outer portion 56B, thereby securing the two portions of barrel 56 against relative axial motion.

Pressure relief valve 34 may then be assembled by threading spring 82 over movable valve member 81 and then threading spring retainer 84 over valve member 81. The pressure relief valve 34 assembly may be inserted within outer end 64B of plunger 64, and feet 87 engaged with receiving notches 89 to secure pressure relief valve 34 in place, using engagement of locating tabs 103 on spring retainer 84 and 101 on dust cover 97 to insert and rotate pressure relief valve 34 appropriately.

Shoulder 46A of spacer ring 46 (FIG. 3) may be placed over and be supported by an upper circumferential edge of splash guard 44. Centrally located apertures in each of diaphragm 40 and support wheel 35 may then be threaded through spindle 31 resulting in diaphragm 40 being disposed between spindle 31 and support wheel 35. The assembly of spindle 31, diaphragm 40 and support wheel 35 is concentrically positioned over spacer ring 46 and shell 33 is threaded over a corresponding threaded outer portion of splash cover 44, thereby completing the assembly of actuator mechanism 30. Outer portion 56B may then be inserted forwardly through aperture 24, and then gasket 63 and nut 65 can be secured thereto to secure internal fault detector 22 in place on transformer 16.

According to an example embodiment of the invention, the following steps may be performed in order to reset internal fault detector 22 from the triggered position. The pressure relief valve 34 is first removed by depressing feet 87 through notches 89 of plunger 64 which allows for pressure relief valve 34 to be pulled out from within bore 64D (see FIGS. 3 and 17). Removal of pressure relief valve 34 may be facilitated by pulling on ring 107 or installation tab 99.

Following this, an elongate object may be inserted into bore 64D and advanced therethrough until the elongate object pushes shuttle 72 against the force exerted by eject spring 70. Continued rearward motion of shuttle 72 engages angled surfaces 137 of shuttle 72 and 118A of lock bar 110 such that lock bar 110 is pivoted at an upward angle relative to inner portion 56A of barrel 56 (see FIGS. 11, 13A and 14F). At this stage, contact of the elongate object with plunger 64 can be used to apply a rearward force to advance plunger 64 in a rearward direction because the front faces 116-1 of arms 116 will no longer be in contact with retaining surface 106B-2 of protrusion 106B. Upon the vertical alignment of trigger notch 139 and trigger pin 50, trigger pin 50 will seat into trigger notch 139. At this point, surface 118B of lock bar 110 slides along angled surface 135 of shuttle 72, so that second longitudinal end 109 of lock bar 110 pivots back downward and to engage with protrusions 106B and 106C of plunger 64 to prevent further motion, thereby returning internal fault detector 22 to the armed position.

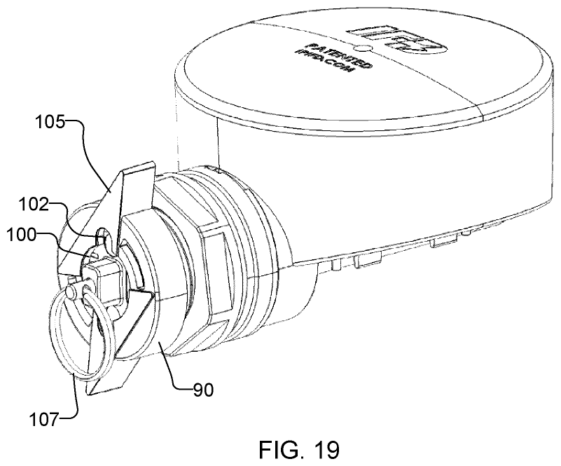

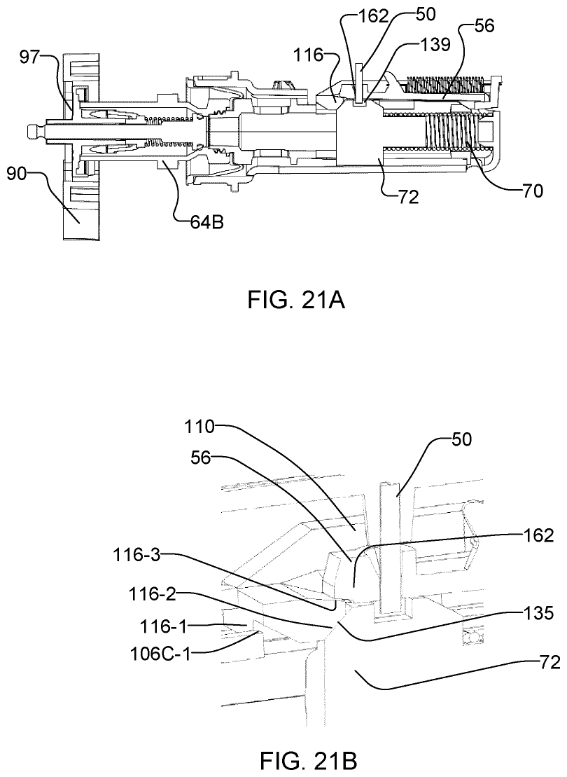

The outer end 56D of barrel 56 can receive a locking device that prevents plunger 64 from accidentally moving to its activated position before internal fault detector 22 is put into service. For example, FIG. 19 shows an internal fault detector 22 wherein a locking device in the form of a shipping lock 90 is installed. Shipping lock 90 attaches to outer end 56D of barrel 56 and blocks plunger 64 from moving forward in bore 56C via interaction with lock bar 110 as described below. Shipping lock 90 can be kept in place until after transformer 16 has been installed, and may be configured to allow diaphragm 40 to float when shipping lock 90 is in place, e.g. by compressing eject spring 70 slightly so that trigger pin 50 is slightly spaced apart from trigger notch 139 of shuttle 72 (best seen in FIG. 21A). After transformer 16 has been installed, and before transformer 16 has been put into service, shipping lock 90 is removed.

The operation of shipping lock 90 is illustrated in FIGS. 21A and 21B. According to an example embodiment, the installation of shipping lock 90 comprises pushing shipping lock 90 against dust cover 97, which in turn pushes on outer end 64B of plunger 64. FIG. 21B is a detailed view showing the engagement of lock bar 110 with catch 162 on barrel 56. The rearward motion of plunger 64 causes the a rearward facing surface 106C-1 of third protrusion 106C on plunger 64 to engage with a forward facing surface 116-1 of arms 116 of lock bar 110. This motion causes the further engagement of rearward facing surface 116-2 of arms 116 with front ramped surface 135 of shuttle 72 to push shuttle 72 rearwardly. Shortly following the engagement of arms 116 with shuttle 72, a rearward end 116-3 of arms 116 engages with a catch 162 located on an interior surface of inner portion 56A of barrel 56. The engagement with catch 162 prevents lock bar 110 from lifting and further prevents the aforementioned components (e.g. lock bar 116, plunger 64, shuttle 72, etc.) from further rearward motion as barrel 56 transfers these forces onto housing 20 of transformer 16. Furthermore, since lock bar 110 cannot pivot upwardly at its second end, forward movement of shuttle 72 is prevented.

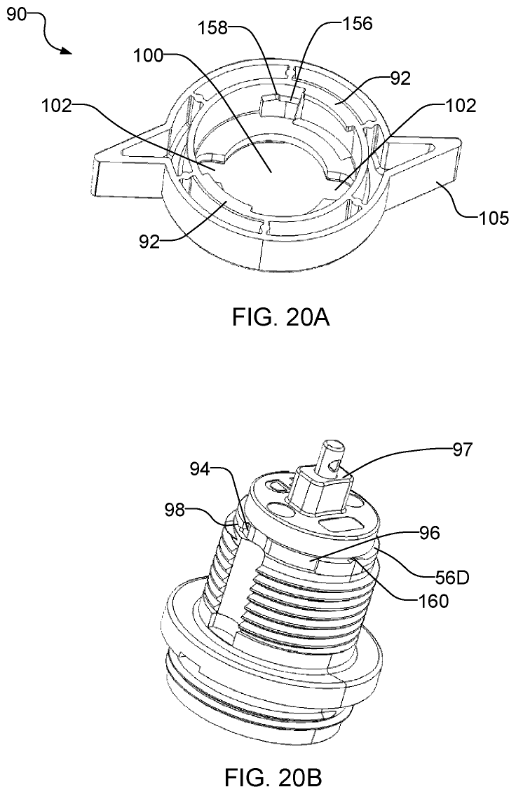

In the illustrated embodiment, shipping lock 90 comprises a pair of inwardly directed flanges 92 (best shown in FIG. 20A) which engage receiving slots 94 on outer end 56D of barrel 56. With reference to FIG. 20B, receiving slots 94 are formed with a receiving portion 96, which opens toward the outer end 56D of barrel 56 to receive flanges 92, and a securing portion 98. Flanges 92 may be fully inserted into receiving portion 96, and then shipping lock 90 may be twisted to secure flanges 92 in securing portion 98 of receiving slots 94. In one embodiment, outer end 56D is provided with four receiving slots 94 equally spaced at 90° intervals. In one embodiment, outer end 56D is provided with two receiving slots 94 equally spaced at 180° intervals. Inserting flanges 94 into receiving portion 96 and rotating shipping lock 90, e.g. 45° or 90° in some embodiments, thus secures shipping lock 90 onto barrel 56. Other numbers and orientations of receiving slots 94 and flanges 92 may be used to secure shipping lock 90 to internal fault detector 22. In some embodiments, the position and orientation of slots 94 and flanges 92 is such as to provide a specific orientation of shipping lock 90 when properly installed. Thus, for example, shipping lock 90 may include extending arms 105, to provide a readily observable visual indication that shipping lock 90 has been installed in the correct orientation. For example, extension of arms 105 in the vertical direction could indicate that shipping lock 90 has been installed correctly, as illustrated in FIG. 19.

A mechanical lock may be provided on shipping lock 90 to provide greater resistance to secure shipping lock 90 in place. For example, in the illustrated embodiment of FIGS. 20A-20B, a small recess 156 is formed on a supporting projection 158 on shipping lock 90. A corresponding engageable projection 160 is formed on the outer end 56D of barrel 56 that engages and sits within recess 156 when shipping lock 90 is in its fully installed position. Shipping lock 90 may be provided with an aperture 100 for accommodating a ring or other graspable member (illustrated as ring 107) on pressure relief valve 34 when shipping lock 90 is secured. Aperture 100 may include radial extensions 102 for permitting ring 107 to readily be passed through shipping lock 90 in only one orientation. When internal fault detector 22 has been deployed and is ready for use, shipping lock 90 may be removed, thereby placing internal fault detector 22 in its unactivated position. When shipping lock 90 is removed, the rearward force applied to plunger 64 is removed, which allows eject spring 70 to move shuttle 72 and rearward end 116-3 of lock bar 110 forwardly, thereby releasing rearward end 116-3 of lock bar 110 from catch 162.

Other types of engagement could be used to removably secure shipping lock 90 to barrel 56 prior to deployment; for example, projections could be provided in place of flanges 92 to engage in a friction fit with appropriately located cavities in place of slots 94. Moreover, the orientation of flanges 92 and slots 94 could be reversed, so that flanges 92 are formed on barrel 56 and corresponding slots 94 could be formed in shipping lock 90. The locking member could alternatively be secured by threaded engagement with barrel 56. Alternatively, the locking device could be a pin (not shown) which passes through an aperture in plunger 64 and therefore prevents plunger 64 from moving longitudinally in barrel 56 until the pin is removed. The locking device could also be, for example, a sliding or pivoting or break-away member at the outer end of plunger 64 which blocks plunger 64 from moving forwardly in barrel 56.

In some embodiments, a one-way flow obstructer is provided within pressure relief valve 34. The one-way flow obstructer preferentially reduces the flow of fluid through pressure relief valve 34 in one direction as compared with the flow of fluid in the opposite direction. The one-way flow obstructer can help to prevent actuator mechanism 30 from becoming activated due to changes in pressure within housing 20 caused by the operation (including manual operation) of pressure relief valve 34. In particular, the inventors have found that some embodiments of actuator mechanism 30 are so sensitive, actuator mechanism 30 can be triggered and indicator mechanism 32 moved to the activated configuration by the changes in pressure caused by manual operation of pressure relief valve 34. Such unintended activation can occur in particular in embodiments in which the interior of housing 20 is maintained in a vacuum state, i.e. at a pressure that is lower than atmospheric pressure.

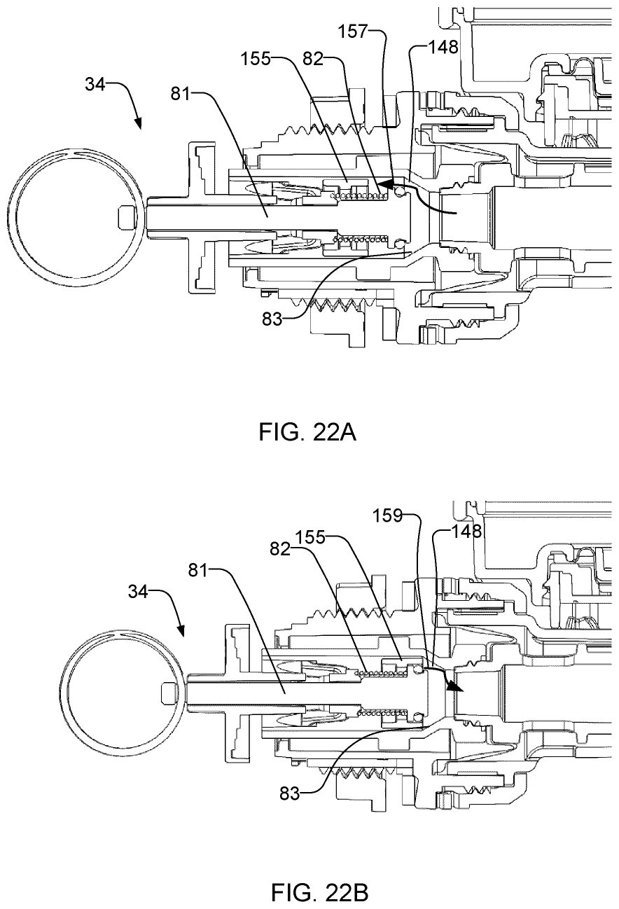

With reference to FIGS. 22A and 22B, in one embodiment, the one-way flow obstructer is an axially movable sealing sleeve 155 that is provided concentrically around valve member 81. In FIG. 22A, the interior of housing 20 is pressurized relative to the external atmosphere (i.e. the pressure inside housing 20 is greater than the ambient atmospheric pressure), and the flow of fluid through venting gap 148 (illustrated by arrow 157) when pressure relief valve 34 is actuated (whether manually or to allow excess pressure within housing 20 to vent) pushes sealing sleeve 155 in an axially outward direction about valve member 81 to a flow position. Thus, the flow of fluid through venting gap 148 is relatively unobstructed by sealing sleeve 155. In some embodiments, this configuration of sealing sleeve 155 when venting housing 20 under an overpressure situation meets IEEE flow rate specifications for pressure relief valves.

In contrast, as illustrated in FIG. 22B, when the interior of housing 20 is at a vacuum pressure relative to the external atmosphere (i.e. the pressure inside housing 20 is lower than the ambient atmospheric pressure), the flow of fluid inwardly through venting gap 148, represented by arrow 159, when pressure relief valve 34 is manually actuated shifts sealing sleeve 155 inwardly, so that sealing sleeve 155 partially or fully obstructs venting gap 148. This reduces (or in some embodiments eliminates) the inflow of fluid into housing 20 sufficiently to avoid inadvertently triggering actuator mechanism 30. In this manner, sealing sleeve 155 does not interfere appreciably with the desired venting functions provided by pressure relief valve 34 allowing applicable performance specifications for the pressure relief valve 34 to be met, but reduces inward fluid flow into housing 20 under a vacuum pressure sufficiently to avoid the unintended effect of triggering actuator mechanism 30 when pressure relief valve 34 is actuated, including when pressure relief valve 34 is manually actuated.

In alternative embodiments, other structures could be used to provide the one-way flow obstructer. For example, a two-way or three-way umbrella valve could be used to preferentially allow fluid to exit housing 20 while slowing the ingress of fluid into housing 20 when pressure relief valve 34 is actuated; a two-part seal having an O-ring in floating contact with an air-permeable base could be used, with the O-ring being pulled into sealing engagement with the air-permeable base when the interior of housing 20 is at a vacuum relative to the external atmosphere, and the O-ring being pushed away from sealing engagement with the air-permeable base when fluid is exiting the interior of housing 20 (i.e. when the interior of housing 20 is pressurized relative to the external atmosphere) to minimize any reduction in fluid flow; various flow restrictors or the shaping and dimensions of various components of pressure relief valve 34 could be used to preferentially favour the exit of fluid out of housing 20 over the inflow of fluid into housing 20; various check valves or one-way valves could be used to limit the inflow of fluid into housing 20, or the like.

Internal fault detector 22 optionally includes a facility for generating a control signal when the internal fault detector is activated. This facility may include one or more sets of electrical contacts which close or open when internal fault detector 22 is activated. The electrical contacts may be operated to generate the control signal, for example, by the passage of plunger 64 in bore 56C, or by the motion of trigger pin 50. The electrical contacts may be in a first position (either closed or open) when plunger 64 is in its armed position. As internal fault detector 22 is activated, the electrical contacts are switched so that when plunger 64 is in its activated position, the contacts are in a second position (either open or closed). The facility may comprise other mechanisms such as fiber optics or a cellular communication signal for communicating a control signal indicating to a transmitter that internal fault detector 22 has been activated. The transmitter may generate a fault signal such as a radio signal or cellular phone transmission in response to the control signal.

In one specific embodiment, a magnetic sensor is used to provide an indication that internal fault detector 22 has been activated. In one embodiment, the magnetic sensor uses the Hall effect to provide an indication that internal fault detector 22 has been activated. The Hall effect exploits the change in voltage across an electrical conductor caused by a change in the magnetic field.

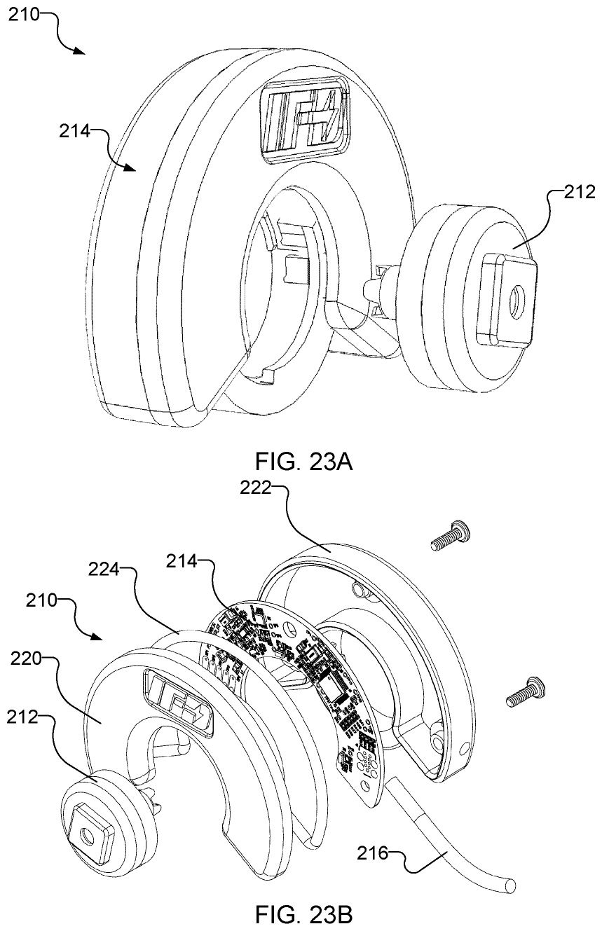

An example embodiment of such a sensor 210 is illustrated in FIGS. 23A and 23B. In one example embodiment, a magnetic element 212 is mounted on plunger 64 so that magnetic element 212 will move forwardly in the longitudinal direction when internal fault detector 22 has been activated. In some embodiments, the magnetic element 212 is mounted on the forward end of plunger 64.

A corresponding Hall effect sensor 214 is mounted in a stationary fashion to a component of internal fault detector 22 that does not move during activation (e.g. to shell 33), or to the housing or tank 20 of the electrical device on which internal fault detector 22 is mounted. In this manner, when internal fault detector 22 is activated, magnetic element 212 will move forwardly, while Hall effect sensor 214 will remain stationary, thereby providing relative movement of magnetic element 212 and Hall effect sensor 214 that can be detected by Hall effect sensor 214.

The movement of magnetic element 212 will cause a change in the voltage within the electrical conductor contained in Hall effect sensor 214 that can be detected and output via a suitable facility, e.g. via a wired connection 216 to a processor as in the illustrated embodiment, or via a wireless communication facility that allows communication of the detected signal for example via cellular or local wireless communications systems.

The signal can be used to provide an alert that internal fault detector 22 has been activated to a remote location, for example a central control station, thereby providing prompt notification of a possible fault within the electrical device in which internal fault detector 22 is installed. Such remote notification can also avoid or decrease the frequency of manual visual inspection of internal fault detector 22, since a user can be remotely notified that internal fault detector 22 has been activated, rather than requiring an on-site visual inspection to make such a determination.

While in the illustrated embodiment, the magnetic element 212 has been shown and described as being movable during activation of internal fault detector 22, in alternative embodiments, Hall effect sensor 214 could be mounted for movement during activation of internal fault detector 22, while magnetic element 212 is retained in a stationary position during activation of internal fault detector 22, or the two components could be mounted in any suitable manner that causes relative motion between them when internal fault detector 22 is activated.

Magnetic element 212 and/or Hall effect sensor 214 can be enclosed in any suitable housing or component of internal fault detector 22, for example to protect these components from adverse environmental conditions. For example, in some embodiments, magnetic element 212 can be mounted inside dust cover 97. In some embodiments, Hall effect sensor 214 can be enclosed within a suitable housing having a front portion 220, a rear portion 222, and a sealing gasket 224, to protect Hall effect sensor 214 from adverse environmental conditions.

Embodiments of an internal fault detector can be designed to project from housing by only a minimal amount. Such a design can limit any surfaces to which snow and ice are likely to adhere, for example.

In some embodiments, the entirety of internal fault detector 22 is disposed exteriorly of housing 20 of transformer 16. For example, in place of aperture 24, a fluid flow path could be provided to enable fluid communication between the interior of housing 20 and an exteriorly disposed internal fault detector 22. Such a fluid flow path enables an externally disposed internal fault detector 22 to detect rapid pressure rises within housing 20. In such embodiments, the fluid flow path should fluidly connect to, or be integral with, a connecting structure that sealingly engages a bottom end of splash cover 44 such that the pressure acting on face 40B of diaphragm 40 is the same as the pressure within housing 20. In one example embodiment, the fluid flow path is provided by a threaded fitting between corresponding threads of an external rigid connector and a threaded orifice disposed on the surface of housing 20. In some embodiments, the threaded orifice may be located in the side wall of housing 20 above fluid 26 or in the lid 21.

Some example embodiments of the invention described above employ the use of a lock bar (e.g. lock bar 110) which interacts with a shuttle (e.g. shuttle 72). The shuttle acts as an interface to decouple the indicator mechanism from the actuator mechanism by interfacing with both the trigger pin (of the actuator mechanism) and the lock bar (of the indicator mechanism). Other embodiments of the invention provide means to decouple the indicator mechanism from the actuator mechanism without the use of an intermediate shuttle.

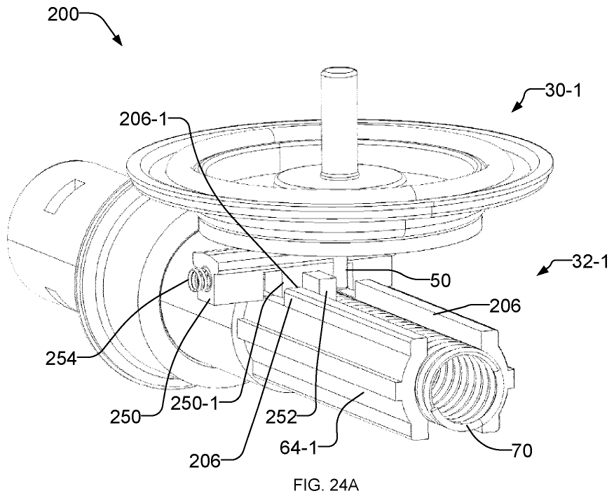

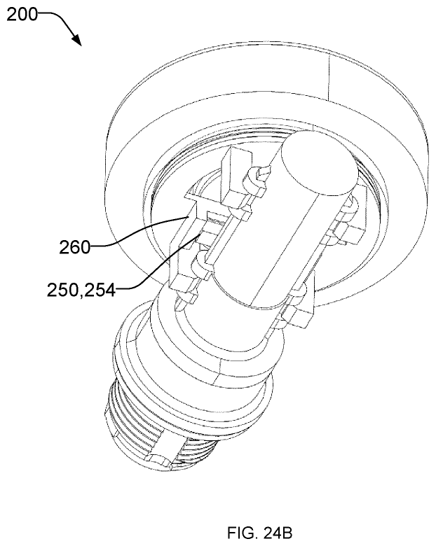

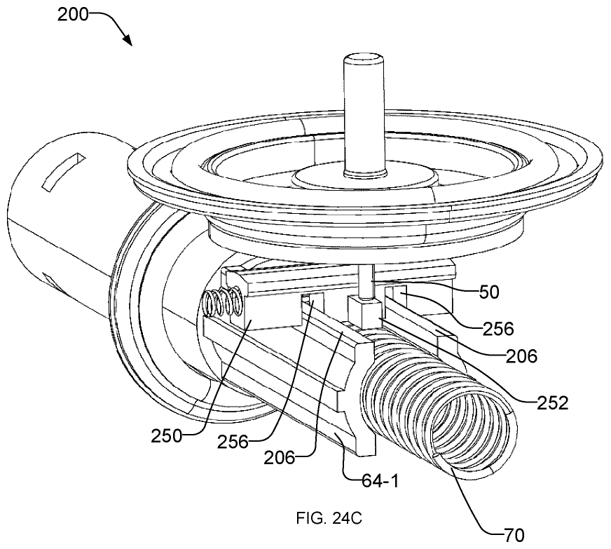

FIGS. 24A-24C show an example internal fault detector 200 (only parts of which are shown) comprising a transversely-oriented lock bar 250 as a means for decoupling an indicator mechanism 32-1 from an actuator mechanism 30-1. Internal fault detector 200 may be similar to internal fault detector 22 described above except for the noted differences. FIG. 24A shows a configuration in which indicator and actuator mechanism 30-1 and 32-1 are unactivated (or armed). As shown, lock bar 250 comprises a protrusion 252 which is proximate trigger pin 50. A spring 254 is provided at a longitudinal end of lock bar 250 to bias lock bar 250 in a transverse direction relative to plunger 64-1.

Although hidden from view in FIG. 24B, spring 254 of lock bar 250 is illustrated as being compressed against an inner surface of splash guard 260 in the unactivated configuration. Referring to FIG. 24A, the compressed spring 254 biases lock bar 250 in a direction transverse to the central axis of plunger 64-1 and away from the surface of splash guard 260 against which spring 254 is compressed. This biasing force acts against trigger pin 50 by way of protrusion 252 in the unactivated configuration which thereby impedes the motion of lock bar 250. Similar to that which is discussed in other embodiments herein, a spring 70 biases plunger 64-1 towards the activated configuration of indicator mechanism 32-1. As best shown in FIG. 24A, plunger 64-1 is retained in the unactivated position by the engagement of forward facing surfaces 206-1 of protrusions 206 against a rearward facing surface 250-1 of lock bar 250.

Upon the triggering of actuator mechanism 30-1, trigger pin 50 becomes disengaged from protrusion 252 to thereby permit free movement of lock bar 250 in the transverse direction under the biasing force applied by spring 254. Lock bar 250 advances in the transverse direction (away from spring 254) until it is impeded by an opposing surface of splash guard 260 (not shown) and resembles the activated configuration illustrated in FIG. 24C.

As illustrated, two slots 256 are defined in lock bar 250, both of which are configured to align with the positions of protrusions 206 when internal fault detector 200 is in the activated configuration. The dimensions of slots 256 may be related to the dimensions of protrusions 206 such that when they are aligned with one another, slots 256 have a greater overall width than protrusions 206. In this manner, when actuator mechanism 30-1 is triggered and lock bar 250 freely moves transversely by the action of spring 254, the alignment of protrusions 206 and slots 256 permits plunger 64-1 to advance to thereby indicate that a fault has occurred, as best shown in FIG. 24C.

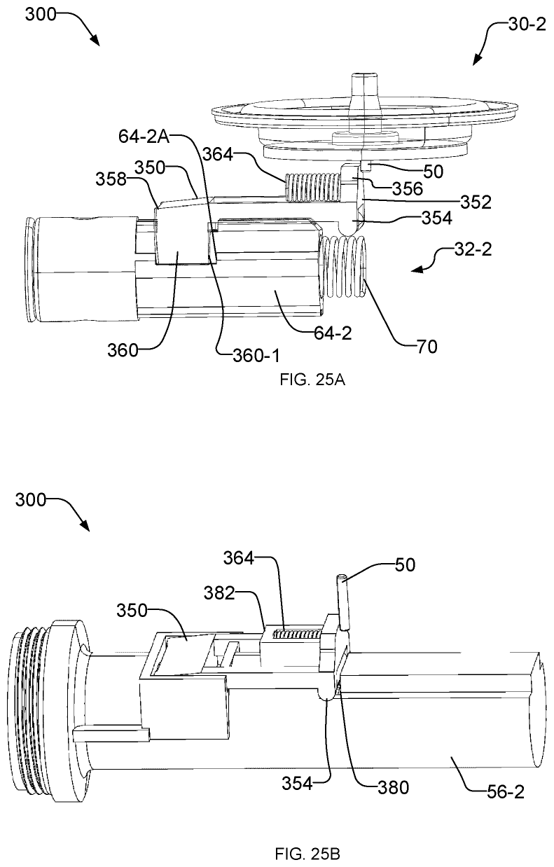

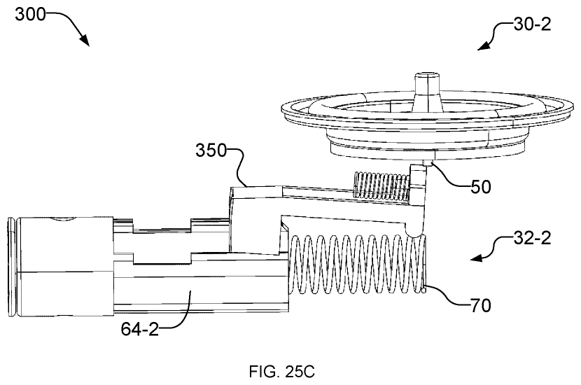

FIGS. 25A-25C show an example internal fault detector 300 (only parts of which are shown) comprising a lock bar 350 as a means for decoupling an indicator mechanism 32-2 from an actuator mechanism 30-2. Internal fault detector 300 may be similar to internal fault detector 22 described above except for the noted differences. FIGS. 25A and 25B show a configuration in which actuator mechanism 30-2 and indicator mechanism 32-2 are unactivated. FIG. 25B shows plunger 64-2 being housed within a barrel 56-2 with lock bar 350 installed thereon. FIG. 25A shows the relative positioning of components where barrel 56-2 is omitted. In the illustrated embodiment, lock bar 350 features a similar overall geometry compared to that of lock bar 110, although this is not necessary. Proximate a first longitudinal end 352, lock bar 350 has a downward extension 354 and an upward extension 356. At an opposite second longitudinal end 358, lock bar 350 has a downwardly extending arm 360.

FIG. 25B shows the installation of lock bar 350 onto barrel 56-2. Barrel 56-2 comprises a groove 380 for receiving downward extension 354 of lock bar 350. Barrel 56-2 further comprises a spring housing 382 in which a spring 364 can be retained. Similar to that which is discussed in other embodiments herein, a spring 70 biases plunger 64-2 towards the activated configuration of indicator mechanism 30-2. When positioned within indicator mechanism 32-2, arm 360 of lock bar 350 comprises a rearward facing surface 360-1 which engages with a forward facing surface 64-2A of plunger 64-2 to prevent the forward motion of plunger 64-2 in the illustrated unactivated configuration of FIGS. 25A and 25B.

Spring 364 biases lock bar 350 into a vertically angled position as the engagement of spring 350 against a forward facing surface of upward extension 356 causes the second longitudinal end 358 of lock bar 350 to pivot upwards about an end of downward extension 354. In the unactivated configuration, a rearward facing surface of upward extension 356 engages with trigger pin 50 of actuator mechanism 30-2 to thereby prevent the pivoting of lock bar 350 and to thus prevent the advancement of plunger 64-2 when internal fault detector 300 is in the unactivated configuration.

Upon the triggering of actuator mechanism 30-2, trigger pin 50 becomes disengaged from upward extension 356 to thereby permit rotation of lock bar 350 by way of the force exerted by spring 364. This action accordingly disengages the surfaces of lock bar 350 from plunger 64-2 to thus allow plunger 64-2 to advance to thereby indicate that a fault has occurred, as best shown in FIG. 25C.

### EXAMPLES

Further embodiments are described with reference to the following examples, which are intended to be illustrative rather than limiting in nature.

### Example 1.0—Determination of Spring Constant for Various Diaphragms

The spring constant k of different diaphragms was experimentally determined using a laser weight method. In brief, a laser sensor was used to measure vertical displacement of the example diaphragms as weights were added to the top side of the diaphragm. In this scenario, the force applied by the added weights under the force of gravity (F=mg where m is the added mass and g is the acceleration of gravity, i.e. 9.8 m/s/s) is equal to kx, where k is the spring constant and x is the measured displacement.

It was experimentally determined that a diaphragm having a double convolution and made from polybutylene terephthalate, such as that illustrated in PCT publication No. WO2011/153604, had a spring constant on the order of 7 lbs/in. In contrast, an example diaphragm having only a single convolution and made from a fluoroelastomeric material had a spring constant on the order of 1.7 lbs/in.

While a number of exemplary aspects and embodiments have been discussed above, those of skill in the art will recognize certain modifications, permutations, additions and sub-combinations thereof. For example:
the single orifice 38 shown in the drawings could be replaced with a number of smaller orifices, a porous membrane whereby air can flow through the membrane but not fluid 26, or some other construction which limits the rate at which the pressure within chamber 36 can follow fluctuations in the ambient pressure within housing 20;
the shape of orifice 38 may be annular, as illustrated, or some other shape;
in place of chamber 36 closed on one side by a flexible diaphragm 40, actuator mechanism 30 could comprise a chamber closed by both a relatively high mass piston and a relatively low mass piston as described in U.S. Pat. No. 5,078,078 to Cuk. The two pistons may be concentric with one another and connected to springs having the same spring constant. The inertia of the large mass piston prevents the large mass piston from moving in response to sudden pressure rises. The large mass piston and the small mass piston can both move in response to slow pressure fluctuations. Relative motion of the large mass and small mass pistons can be used to release indicator mechanism 32;
chamber 36 may comprise the interior of a bellows having rigid end faces joined by a flexible cylindrical wall. Relative motion of the rigid end faces can trigger indicator mechanism 32 by way of a suitable mechanical linkage. One or more openings in the bellows will prevent the end faces from moving in response to slow fluctuations in the ambient pressure within housing 20;
in non-preferred embodiments of the invention, diaphragm 40 could be replaced with a rigid or semi-rigid movable piston which is displaced toward chamber 36 in response to sudden pressure rises within housing 20;
a chamber 36 closed on one side by a diaphragm, as described above, for example, or any of these alternative mechanisms constitute “pressure rise detecting means” which respond to rises in pressure within housing 20 by moving a portion of a wall of a cavity with a force sufficient to operate an indicator mechanism 32; or
plunger 64 may have a different shape from the shape described above, for example, plunger 64 could comprise a flag, rod, plate, or the like having hidden portions which are hidden from view within bore 56C when plunger 64 is in its armed position and are revealed when plunger 64 moves to a triggered position. A plunger 64 as described above, and any of the alternatives described herein for displaying an indication that internal fault detector has detected a fault, constitute “indicator means”.

It is therefore intended that the following appended claims and claims hereafter introduced are interpreted to include all such modifications, permutations, additions and sub-combinations as are within their true spirit and scope.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. (canceled)

2. A fault detector for indicating the occurrence of a rapid pressure rise within a housing of an electrical device, the fault detector comprising:
a barrel;
an actuating mechanism in fluid communication with an interior of the housing, the actuating mechanism comprising:
a chamber, the chamber being sealed and having an orifice communicating between an external environment of the chamber and an interior of the chamber; and
an actuating member movable in response to a pressure differential between the interior of the housing and the interior of the chamber, the actuating member comprising a spring constant of 5 lbs/in or less; and
a plunger within a bore of the barrel, the plunger biased forwardly in the barrel and normally retained in an armed position by the actuating member;
wherein, when the pressure differential exceeds a positive threshold value, the actuating member is moved and thereby permits the plunger to move forwardly into a triggered position.

3. (canceled)

4. A fault detector as defined in claim 2, wherein the actuating member comprises a diaphragm in sealing engagement with the chamber at a sealing surface of the chamber to define a portion of the surface of the chamber.

5. (canceled)

6. (canceled)

7. (canceled)

8. (canceled)

9. (canceled)

10. (canceled)

11. (canceled)

12. A fault detector as defined in claim 4, wherein the diaphragm comprises cup, the cup comprising a downward depression which extends radially inwards, wherein the diaphragm further comprises a single annular ridge disposed interiorly of the sealing surface of the diaphragm and wherein the downward depression of the cup is disposed at an inner edge of the annular ridge.

13. (canceled)

14. A fault detector as defined in claim 2, wherein the diaphragm comprises a top hat diaphragm, and wherein the single annular ridge is provided during at least part of a period of time during which a rapid pressure rise is detected.

15. A fault detector as defined in claim 2, wherein the diaphragm undergoes large scale non-elastic motion in response to the pressure differential.

16. (canceled)

17. (canceled)

18. (canceled)

19. (canceled)

20. (canceled)

21. (canceled)

22. (canceled)

23. (canceled)

24. A fault detector for indicating the occurrence of a rapid pressure rise within a housing of an electrical device, the fault detector comprising:
a barrel;
an actuating mechanism in fluid communication with an interior of the housing, the actuating mechanism comprising:
a chamber, the chamber being sealed and having an orifice communicating between an external environment of the chamber and an interior of the chamber; and
an actuating member movable in response to a pressure differential between the interior of the housing and the interior of the chamber to cause the actuating member to move from an unactivated configuration to an activated configuration;
a plunger within a bore of the barrel; and
a locking member having a first position and a second position, wherein in the first position the locking member is positioned to restrain forward movement of the plunger in the barrel and to prevent a transfer of forces applied to the plunger to the actuating member and in the second position the locking member is positioned to allow forward movement of the plunger, the plunger being initially retained in the unactivated configuration by the locking member when the locking member is in the first position and the plunger being movable forwardly within the bore of the barrel when the locking member is in the second position;
the locking member being movable from the first position to the second position in response to movement of the actuating member from the unactivated configuration to the activated configuration.

25. A fault detector as defined in claim 24, further comprising a shuttle biased forwardly in the barrel by a biasing force, the shuttle being initially retained in the unactivated configuration by the actuating member and being configured to move forwardly to transfer the biasing force to the plunger when the actuating member moves from the unactivated configuration to the activated configuration, the shuttle being configured to displace the locking member from the first position to the second position when the actuating mechanism is triggered.

26. A fault detector as defined in the claim 25, wherein in the first position, an arm of the locking member is engaged with a first protrusion on the plunger to thereby restrain forward movement of the plunger in the barrel.

27. A fault detector as defined in claim 26, wherein in the first position, an arm of the locking member is engaged with a second protrusion on the plunger to restrain rearward movement of the plunger in the barrel.

28. A fault detector as defined in claim 26, wherein in the second position, the arm of the locking member is deflected by the shuttle to remove the arm of the locking member from engagement with the first protrusion on the plunger.

29. A fault detector as defined in claim 28, wherein the shuttle comprises a first ramped surface that is complementary to and in contact with a second ramped surface on the locking member, the first and second ramped surfaces being configured so that horizontal movement of the shuttle in the forward direction causes vertical movement of a first end of the locking member via the sliding displacement of the second ramped surface relative to the first ramped surface.

30. (canceled)

31. A fault detector as defined in claim 29, wherein the locking member is moved from the first position to the second position by sliding of the first ramped surface past the second ramped surface.

32. A fault detector as defined in claim 24, wherein the locking member has a third position in which the locking member is positioned to prevent further forward movement of the plunger.

33. A fault detector as defined in claim 32, wherein the shuttle comprises a third ramped surface that is complementary to and in contact with a fourth ramped surface on the locking member, the third and fourth ramped surfaces being configured so that horizontal movement of the shuttle in the rearward direction causes vertical movement of the first end of the locking member via the sliding displacement of the fourth ramped surface relative to the third ramped surface.

34. (canceled)

35. (canceled)

36. (canceled)

37. (canceled)

38. (canceled)

39. (canceled)

40. A method of activating an internal fault detector, comprising:
allowing a rapid pressure rise to actuate a pressure sensor;
moving a retaining pin in response to the actuation of the pressure sensor to allow a locking member to move from an unactivated configuration to an activated configuration; and
allowing a plunger that is retained by the locking member when the locking member is in the first position to be forwardly displaced by the biasing force when the locking member is in the second position to provide an indication that a rapid pressure rise has occurred;
wherein the locking member in the unactivated configuration is configured to prevent a transfer of forces applied to the plunger to the retaining pin.

41. (canceled)

42. (canceled)

43. A fault detector as defined in claim 24, wherein the locking member is biased transversely in the barrel by a first biasing force and the plunger is biased forwardly in the barrel by a second biasing force, the locking member being initially retained in the unactivated configuration by the actuating member, wherein the first biasing force displaces the locking member from the first position to the second position when the actuating mechanism is triggered.

44. (canceled)

45. (canceled)

46. (canceled)

47. (canceled)

48. (canceled)

49. (canceled)

50. A fault detector as defined in claim 2, further comprising a shipping lock for preventing activation of the fault detector.

51. (canceled)

52. (canceled)

53. (canceled)

54. A fault detector for indicating the occurrence of a rapid pressure rise within a housing of an electrical device, the fault detector comprising:
a barrel;
an actuating mechanism in fluid communication with an interior of the housing and configured to release an actuating member in response to a rapid pressure rise within the housing;
a plunger within a bore of the barrel, the plunger biased forwardly in the barrel and normally retained in an armed position by the actuating member; and
a static seal having a first end fixedly retained on the plunger and a second end fixedly retained on the barrel, the static seal having a central portion that permits relative movement of the plunger and the barrel when the fault detector moves from an armed to a triggered configuration while maintaining a seal between the interior of the housing and an external environment of the housing.

55. (canceled)

56. (canceled)

57. (canceled)

58. (canceled)

59. (canceled)

60. (canceled)

61. (canceled)

62. (canceled)

63. (canceled)

64. A method of activating an internal fault detector, comprising:
allowing a rapid pressure rise to actuate a pressure sensor;
moving a retaining pin in response to the actuation of the pressure sensor to allow an indicator positioned within a barrel to be displaced by a biasing force to provide an indication that a rapid pressure rise has occurred,
while retaining a first end of a static seal in sealing engagement with the barrel and retaining a second end of a static seal in sealing engagement with the indicator while a flexible central portion of the static seal slides past itself.

65. A fault detector as defined in claim 2, comprising:
a magnetic element; and
a Hall effect sensor positioned to detect relative movement of the magnetic element and the Hall effect sensor;
wherein at least one of the magnetic element and the Hall effect sensor is mounted for relative movement during activation of the fault detector.

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)
